(19) United States
(12) Patent Application Publication
(10) Pub. No.: US 2017/0178110 A1
(43) Pub. Date: Jun. 22, 2017

(54) Private Payee-Controlled Compensation Disbursement System to Multiple Payee Directed Disbursement Devices

(71) Applicants: David Benjamin Swanson, Sarasota, FL (US); David Marvin Swanson, Sarasota, FL (US); Bryan Keith Lindsay, Highland Beach, FL (US)

(72) Inventors: David Benjamin Swanson, Sarasota, FL (US); David Marvin Swanson, Sarasota, FL (US); Bryan Keith Lindsay, Highland Beach, FL (US)

(21) Appl. No.: 14/977,438

(22) Filed: Dec. 21, 2015

(51) Int. Cl. G06Q 20/22; G06Q 20/36; G06Q 20/40

(52) U.S. Cl. CPC G06Q 20/223; G06Q 20/401; G06Q 20/363

(57) ABSTRACT

Present Invention enables non-cash-paid workers/vendors to rapidly receive net or gross compensation for rendered services/products with or without personal access to banking—unlimited by time and volume restrictions currently imposed by private label pay cards and systems. Present invention is a method, via a client server system, by which a Compensation Payer can issue individual or bulk funds to a secure Payer account—accompanied by (a) payment manifest(s)—which automatically and verifiably distributes to Payee-controlled accounts from which Payees can privately direct some or all of the received compensation to multiple Payee-Directed Disbursement Devices, including, without exclusion of others, direct deposit, paper/e-checks, money orders, and virtually any kind, number, and combination of verifiably legitimate debit, credit, gas, phone, gift, or store cards, prioritized, among others, by card, card type, and dollar amounts at Payee's directions received prior to or anytime after a specific payout disbursement.

### FIELD OF THE INVENTION

The present invention relates generally to a client server system. Present invention relates more specifically to a client server system that allows Payers to offer broad Payout options to Payees without additional Payer involvement, accounting, interaction, liability, or cost.

Present invention relates more specifically to software services that can be utilized as a stand-alone pay system or as an add-on option to an existing Pay system. Present invention relates more specifically to software services that give subscribed Payers the option of handling payouts to one or more Payees via bulk transfers of funds as well as using multiple transfers to multiple Payees.

Present invention relates more specifically to software services that monitor the cash balance from the Payer in the receiving transfer account, monitoring the funds against the Payment Manifest from the Payer and alerting Payer of any discrepancies, including, but not limited to, insufficient funds. Present invention relates more specifically to software services that will distribute as many received funds from Payer according to Payer's Payment Manifest as the amount of received funds will allow, holding any other disbursements until sufficient funds have been received.

Present invention relates more specifically to software services that allow Payers to cancel (or withdraw Payout Request) for any designated Payee for any reason deemed necessary by Payer up to the moment that such Payee disbursement has been tagged as “Processing” or “Paid”.

Present invention relates more specifically to software services that automatically execute Payout distribution of said bulk funds to Payees according to an accompanying Payer-generated Payment Manifest.

Present invention relates more specifically to software services that verifiably distribute said bulk funds as directed by the accompanying Payment Manifest to Payee-registered and controlled pay accounts (otherwise known as “Payee-Directed Disbursement Accounts”—“PDDAs”).

Present invention relates more specifically to software services that allow each registered Payee at all times to privately and securely receive, accumulate, access, control, and disburse in whole or in part the funds received in his or her individual PDDA.

Present invention relates more specifically to software services that enable subscribed Payees to immediately access 100% of their received Payment Event funds through one or more Payee Directed Disbursement Cards (“PDDCs”) which cards are issued to the respective Payees and linked to their PDDAs.

Present invention relates more specifically to software services that enable subscribed Payees to privately self-direct disbursement of funds received in their PDDAs by means other than by cash whether or not such Payee has access to conventional banking or bank accounts.

Present invention uniquely relates to software services that allow subscribers to privately control and channel some or all of Payee's funds received in their individual PDDA from any particular Payment Event or Events—where such funds have not been paid out or withdrawn via the directly linked cards—and simultaneously access, utilize, and disburse such remaining funds in whole or in part to one or more Payee Directed Disbursement Devices (“PDDD”) such as, without exclusion, direct deposits, “e-checks”, physical paper checks, money orders, and multiple reloadable electronic payment cards and accounts, thereby eliminating the constraints, limitations, and hardships imposed by currently used single-pay payment cards when such cards are used in lieu of checks or direct deposit of compensation funds.

### BACKGROUND OF THE INVENTION

Wherever cash for hire or payment is no longer a viable option, workers/vendors have been forced to accept bank drafts or other forms of facsimile payment for services rendered or products delivered. However, rising costs in actual involved materials and personnel commitment have led most Payers of Compensation to opt for electronic direct deposit of funds as more efficient and economical means of worker service payment.

Direct deposit is not without costs, as each transmission (typically via an ACH transfer) has a fee attached to it. But compared with the financial burden of generating paper checks, direct deposit represents significant savings.

However, because of the recent economic downturn and slow recovery since, a growing segment of the work force find themselves unbanked or unbankable for varying reasons.

Poor credit often precludes qualification for a bank account. For others, because of the risks of judgments and garnishments from foreclosure, default, and other actions, having a bank account that could be swept of money being counted on for day-to-day living expenses exposes Payees to extreme hardship and possible final financial ruin.

There is also a rising culture of those who do not trust banks who, instead, prefer to be self-banked. This group, combined with those who are unbankable, is estimated as high as 34-37% of the population.

Without a bank account, direct deposit is impossible. Unfortunately, where the fallback method of pay receipt is a paper check, banks, even the very branches upon which payroll or compensation checks are drafted, want to charge fees to cash their own checks when the Payee does not have an account with that same institution. And third party check cashing services often charge rates as high as ten percent (10%) of the face amount for cashing commercial checks—a further financial blow to the already struggling Payee.

This poses another problem. Having to cash an entire check at one time leaves Payees vulnerable to criminal attack, such attacks estimated to occur at a rate as high as 25% among unbanked check cashers.

One industry answer has been the use of a single debit-based payment card per worker that can function much like any other credit or debit card when loaded with the latest compensatory amount. Most often, such cards are privately labeled, bearing the name/logo of the Compensation Payer (though the cards themselves may be of a major brand type). Such cards may be used to service the needs of unbanked workers specifically or used uniformly for all Payees.

In fact, there is a growing trend away from direct deposit toward a pay card system, even when banking and direct deposit are available to Payees.

Unfortunately, such cards can create unwelcome hardships, because they often come with limitations such as these.

(1) Some cards have restrictions as to how much can be paid on them at a given time.

(2) Not all vendors—including most landlords—accept them for payment for goods and services, meaning another step or steps are required to convert what is on the card to a form acceptable to the creditor/vendor.

(3) There are restrictive daily limits as to how much can be spent or withdrawn, meaning it can be several days and multiple trips to an ATM to get money together for rent or other large expenditures.

(4) Some of the more popular card systems that do allow for a transfer of funds from the pay card to a bank account can take as many as six days to do so.

(5) For those who try to pay bills—such as credit card bills or other types of timed payments—the added hassle and time necessary to convert an electronic payment card to sufficient cash which can be deposited in an account for writing a check or converted to a money order may wind up indirectly costing late fees, depending upon the timing of the pay cycle.

Furthermore, use of a debit-based payment card does not reflect positively on the credit score of someone trying to establish or rebuild credit.

The cumulative effect of the lack of choice and flexibility puts Payees at a distinct disadvantage when it comes to accessing and utilizing their funds.

Some attempts have been made to try to improve the situation for Payees but not without engendering additional potential problems.

In one expression of existing art, claim is made by its proponents that it helps employers attract and keep satisfied workers by offering a benefit to the Payer's Payees in the form of discounts offered by local or chain merchants through the funding of vendor-specific debit or gift cards. Such cards may range from grocery stores to gasoline stations and most any type of merchant or vendor between. A system is provided whereby the employer or Payer of Compensation encourages the Payees to sign up for one or more of a small handful of electronically reloadable prepaid debit cards that purportedly allow the users to enjoy a set discount (supposedly uniquely negotiated by the Payer for the exclusive benefit of the Payees/employees) whenever the card is presented for payment for goods and services at the issuing vendors' places of business.

But, unknown to the Payee, the Payer always has a financial stake in the cards that are offered. As this is typically a negotiated amount, the net effect is that Payers might easily tend to offer the card or cards which bring them the most reward, which would have the effect of restricting the types and numbers of cards to the Payer's choice rather than to the Payees' choice. In all instances in this regard, Payees' have limited options other than to sign up (or not) for the card or cards and to set the amount to be taken from the pay stream and applied to the designated card(s) each time there is a Payment Event.

Obviously, the inducement to the workers to participate is the chance of a discount—if in fact the vendor is one that the Payees would patronize anyway.

Once Payees have signed up in the system and have regularly committed to the proffered cards, Payees have no choice but to use the cards if they are to extract the value of the funds loaded onto them.

The obvious benefit to the card issuers, (the stores/vendors to whose account the debit cards are loaded) is that they are guaranteed an ongoing revenue stream when funds are routinely loaded onto and spent from the cards. The system provides further monetary benefit to the card gateway institution which reaps a fee each time a purchase is logged to one of the system cards.

Discount benefits aside, Payees likely do not know of the Payer's (employer's) incentive in the form of a cash reward (a/k/a “spiff”, bonus, or “bounty”) paid by the card issuers or card gateway institution for each card a Payer convinces a Payee to sign up to use. However, what employers may not take into consideration prior to signing up for such a system is the ongoing bookkeeping and liability headache they assume by technically “spending” their Payees'/employees money for them and having to keep track of sensitive and potentially vulnerable private financial information.

In any case, it is the employer who controls the card choices and who also has access to the Payees' private information as it relates to the use and loading of the specified cards, a scenario with which many Payees may feel uncomfortable.

There is another iteration of existing art that, in fact, is very similar to the first and is somewhat of a further extension of the previous model. A system or mechanism is provided whereby an employer can take an even broader role in sending moneys to multiple receivers on behalf of Payees/employees at the time of a Payment Event. Payees fill out forms which identify and reveal confidential information about accounts, amounts, and parties to whom the Payees wish portions of their pay to be sent. In this scenario, apart from the “float”, there is no monetary incentive for the employer to take on this added responsibility and headache. Yet, as with the first system, this second iteration leaves the Payee/employee at a distinct privacy disadvantage in relation to the HR or Personnel/Bookkeeping departments of their place of work and puts the Payer/employer in a heightened position of potential liability should there be a security breach or any missed communication or failure to carry out the Payees' wishes.

Such deficiencies in meeting basic needs for economic survival among a significant and growing portion of the population at large comprise the void that is being filled by the present invention and may further fuel the movement to electronic payment usage for compensating Payees.

### SUMMARY OF THE INVENTION

The present invention concerns a simple, affordable, easy to use, highly secure software-driven client/server system that provides, among other functions and modalities, a Payer's user interface whereby Payers of Compensation (whether for services or goods) can greatly simplify the fulfillment of their Payment Event obligations to their Payees, lessen their time and processing costs, reduce their current Payer/Payee privacy and Payee bank record retention liabilities, and greatly enhance their Payees' access to funds and other benefits.

The present invention concerns a highly secure software-driven client/server system whereby Payers of Compensation establish a Payer-controlled Payout Account (“PCPA”) to which Payers can at any time send single designated compensation payments (in the case of individual Payees) or one or more bulk compensation payments (where there are multiple Payees enrolled in the system) and from which payouts to Payees will be deducted and paid over to Payee-Directed Disbursement Accounts (“PDDAs”).

The present invention can be (1) used by the Payer as the primary or sole payment solution for all Payees, (2) offered as an option by the Payer to the collective Payees to individually replace their standalone system, (3) offered as an option by the Payer to the collective Payees to be used in conjunction with a system already in place, or (4) implemented and invoked by individual Payees or selective groups of Payees with or without other fellow Payee participation.

Present invention allows Payer funds to be transferred to the Payer-Controlled Payout Account by multiple means—such as, though not exclusive to, ACH transfer, bank wire, or merchant account.

Present invention, through its system software, (1) enforces a protocol by which a Payer generates and submits to the system (a) Payment Manifest(s) which describe the amount(s) to be paid and the Payee(s) to whom such amount(s) is/are to be paid, (2) monitors the amount of funds in the Payer's Payout Account and compares the balance of available funds against the obligations of the Payment Manifest(s), and (3) communicates any existing or pending deficiencies to the Payer and suggests possible remedies.

When the funds in the Payer's Payer-Controlled Payout Account match the figures and Payout dates in the Payment Manifest(s), the present invention's system follows the directives of the Payer's Payment Manifest and automates and executes the distribution of compensation to the Payees, which compensation, unless otherwise instructed by Payees, is loaded into Payees' individual Payee-Directed Disbursement Accounts (“PDDAs”), at which time the present invention's system sends back to the Payer confirmation of the completed total distributions (with no particulars beyond the named Payees and total Payout Amounts to each), thereby ending the Payer's liability for fulfilment of Payer's pay obligations to Payees without exposing or disclosing sensitive Payee information.

Once funds hit the Payees' Payee-Directed Disbursement Accounts, Payees have immediate access to 100% of such funds through one or more Payee Directed Disbursement Cards (“PDDCs”) issued to the respective Payees and linked to their PDDAs.

The present invention provides each Payee a private Payee Client User Interface (“PCUI”) by which, at any time, to establish/edit secure identity, receive Payee input as to full particulars for registering one or more Payee Directed Disbursement Devices (“PDDDs”), establish, control, edit, and carry out Payee's disbursement wishes according to Payee's instructions for loading amounts, loading frequencies, and loading sequences via drag-and-drop accessibility.

Any and all funds not accessed/spent via the PDDC remain in the PDDA and are available and can be accumulated, controlled, and disbursed in whole or in part virtually simultaneously at the time of a Payment Event—or any time subsequent—at Payee's direction to the Payee's choice of one or multiple PDDDs (1) without Payee's need of a personal bank account, (2) without the typical constraints and limitations of a conventional single card Pay Card system, (3) without limitations placed upon Payees' disbursement selections by Payer-determined choices, (4) without in any way relying on the Payer of compensation to carry out such disbursement directions, and (5) without in any way disclosing the details of such actions and disbursements to any party or system directly connected with and/or accessible to the Payer of compensation where such details could become known internally or through a Payer-side security breach.

The present invention's private user interface also allows more sophisticated tracking and override features to implement such options as overdraft protection, credit monitoring, automated bill payment services, maintaining Payee-set debt-to-credit balance ratios, and others.

A more complete understanding of the present invention may be derived by referring to the detailed description of the invention when considered in connection with the Figures.

### BRIEF DESCRIPTION OF THE INVENTION DRAWINGS

Present Invention will be described by illustrations or examples that in no way limit the functionality to the specific examples given while similar references within the illustrations denote similar elements. Further, illustrations, though shown sequentially for numbering purposes, may have one or more of the functionalities or modalities being represented that do not necessarily occur in sequential or consecutive order and may, in fact, take place simultaneously or within milliseconds of another. Embodiments shown in FIGS. 1-13 primarily illustrate systems/mechanisms having to do with the present invention's facilitation of PAYER′S side of the Payment Event transactions and loading of a Payer's-Controlled Pay Account. Embodiments in FIGS. 14-26 illustrate systems/mechanisms having to do with the PAYEE'S self-direction and disbursement of the Payment Event proceeds.

FIG. 1 (elements 01000-01020) is a simplified overview flowchart of the Present Invention representing the flow of compensation from Payer through a client server system and multiple steps of the mechanism whereby Payee takes direct control over the disbursement of said compensation and ultimately to the possession of Payee without the loss of Payee's privacy, which simplified steps are more fully illustrated in the figures that follow.

FIG. 2 (elements 02000-02036) is a diagram illustrating the elements of the Present Invention's Client Server System which facilitate the flow of compensation from the Payer to the disbursement control and possession of the Payee.

FIG. 3 (elements 03000-03008) is a flowchart illustrating the Present Invention's System's sign-in and verification steps for Payers and Payees when interacting with the Present Invention's Server.

FIG. 4 (elements 04000-04018) illustrates what the online Payer New Payment Form (accessible to Payer via Payer's client) might look like whereby a compensation Payer identifies a Payee and designates a compensation amount to be paid to same for a new Payment Event.

FIG. 5 (elements 05000-05020) is a flowchart that illustrates the steps handled by the Present Invention's System whereby a Payer of compensation triggers the creation of a Payment Event Record.

FIG. 6 (elements 06000-06014) is a flowchart illustrating how the Present Invention's System receives electronic notification from a bank or financial institution of a Funding Event, via bank or financial institution's API, and handles said funds in a Payer's escrow Pay Account, a/k/a “Payer-Controlled Pay Account” (“PCPA”).

FIG. 7 (elements 07000-07014) is a flowchart illustrating how the Present Invention's System receives electronic notification from a bank or financial institution of a Funding Event, via merchant account, and handles said funds in a Payer's escrow Pay Account.

FIG. 8 (elements 08000-08030) is a flowchart illustrating the multi-query process by which the Present Invention's System retrieves and handles, via database triggers, updated Payment Event records with status set to “Process”.

FIG. 9 (elements 09000-09018) is a flowchart illustrating how the Present Invention's System retrieves, via database trigger or external process, and handles Payment Event records with status set to “New” or Insufficient Funds”—sorted by oldest to newest.

FIG. 10 (elements 10000-10020) is a flowchart illustrating how the Present Invention's System tracks and updates the records of a Payee who has been allocated compensation but does not have an active Payee-Directed Disbursement Account and how the present invention's system works with said Payee to achieve a “Confirmed” and “Active” status.

FIG. 11 (elements 11000-11014) is a flowchart illustrating how the Present Invention's System retrieves Payment Event records with status set to “Processed” via database trigger.

FIG. 12 (elements 12000-12022) is a flowchart illustrating how the Present Invention's System retrieves and handles Payment Event records with status set to “Cancel” via database trigger.

FIG. 13 (elements 13000-13038) illustrates what a typical Payer Payment Transaction report might look like either during the course of or after completion of a Payment Event.

FIG. 14 (elements 14000-14020) is a simplified flowchart illustrating the basic process by which the Present Invention's System allows a Payee to take control of funds in Payee's Payee-Directed Disbursement Account. (Cf. FIG. 1.)

FIG. 15 (elements 15000-15028) illustrates what an online or server accessible New Payee Account Confirmation Form generated by the present invention might look like whereby a new Payee is granted access to complete the input of necessary information in order for the Payee to gain access to and take control of the Payee's User Interface.

FIG. 16 (elements 16000-16010) illustrates what an interface page of the Present Invention looks like whereby a Payee can privately and securely add a new Payee-Directed Disbursement Device (“PDDD”) in the form of a reloadable credit or debit card.

FIG. 17 (elements 17000-17032) illustrates what an interface page of the Present Invention looks like where a Payee can privately and securely edit preferences governing a new or existing PDDD—this one in the form of a reloadable credit or debit card—and set parameters that will govern its usage unless or until changed by Payee at a subsequent time.

FIG. 18 (elements 18000-18020) illustrates what an interface page of the Present Invention looks like where a Payee can privately and securely edit preferences governing a new or existing PDDD—this one in the form of a bank account—and set parameters that will govern its usage unless or until changed by Payee at a subsequent time.

FIG. 19 (elements 19000-19030) illustrates what an interface page of the Present Invention looks like where a Payee can privately and securely edit preferences governing a new or existing PDDD—this one in the form of a paper check—and set parameters that will govern its usage unless or until changed by Payee at a subsequent time.

FIG. 20 (elements 20000-20028) illustrates an online or client server Payee Account Disbursement Request Form generated by Present Invention's System whereby a Payee can privately and securely request some or all currently available funds in their Payee-Directed Disbursement Account (“PDDA”) to be transferred to their current Disbursement List or to a specific PDDD.

FIG. 21 (elements 21000-21014) illustrates an online or client server “Manage Disbursements” page generated by the Present Invention's System whereby a Payee can privately and securely review and manage all current or pending disbursement requests for one or more Payment Events by dragging and dropping icons representing specific PDDDs into a preferred loading order as well as by giving Payee access to deactivate, edit, or remove one or more PDDDs from the loading list. This page can be accessed at any time before or subsequent to a particular Payment Event, and parameters can be set that will govern present and future disbursements unless or until changed by Payee at a subsequent time.

FIG. 22 (elements 22000-22004) illustrates the Present Invention's online or client server action on the Manage Disbursements page (FIG. 21) whereby one or more of a Payee's PDDDs is moved into a new loading order, with this illustration showing the before, during, and after positions as the changes are being made.

FIG. 23 (elements 23000-23022) is a flowchart which illustrates the internal steps whereby Present Invention's System retrieves and processes Payee Account Event records with status set to “Load to PDDD” via database trigger.

FIG. 24 (elements 24000-24012) is a flowchart which illustrates the internal steps whereby Present Invention's System creates PDDD transaction records for each PDDD in Payee's PDDD list as modified by certain other triggers such as Automatic Overdraft Protection.

FIG. 25 (elements 25000-25018) is a flowchart which illustrates the internal steps whereby Present Invention's System retrieves and handles unprocessed PDDD transactions via a database trigger.

FIG. 26 (elements 26000-26026) illustrates what the Payee Account Overview page looks like when generated by the Present Invention's System on the Present Invention's Client Server System, where each disbursement is tracked and labeled as to its status while updating the Payee's Payee-Directed Disbursement Account balance.

### DETAILED DESCRIPTIONS OF ILLUSTRATIVE EMBODIMENTS

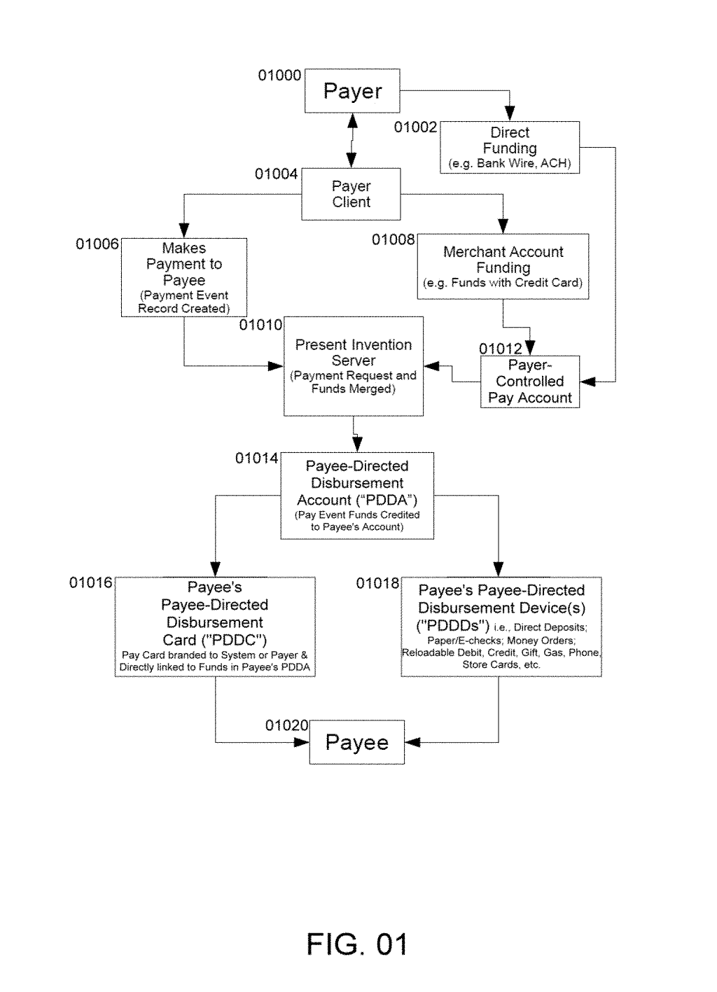

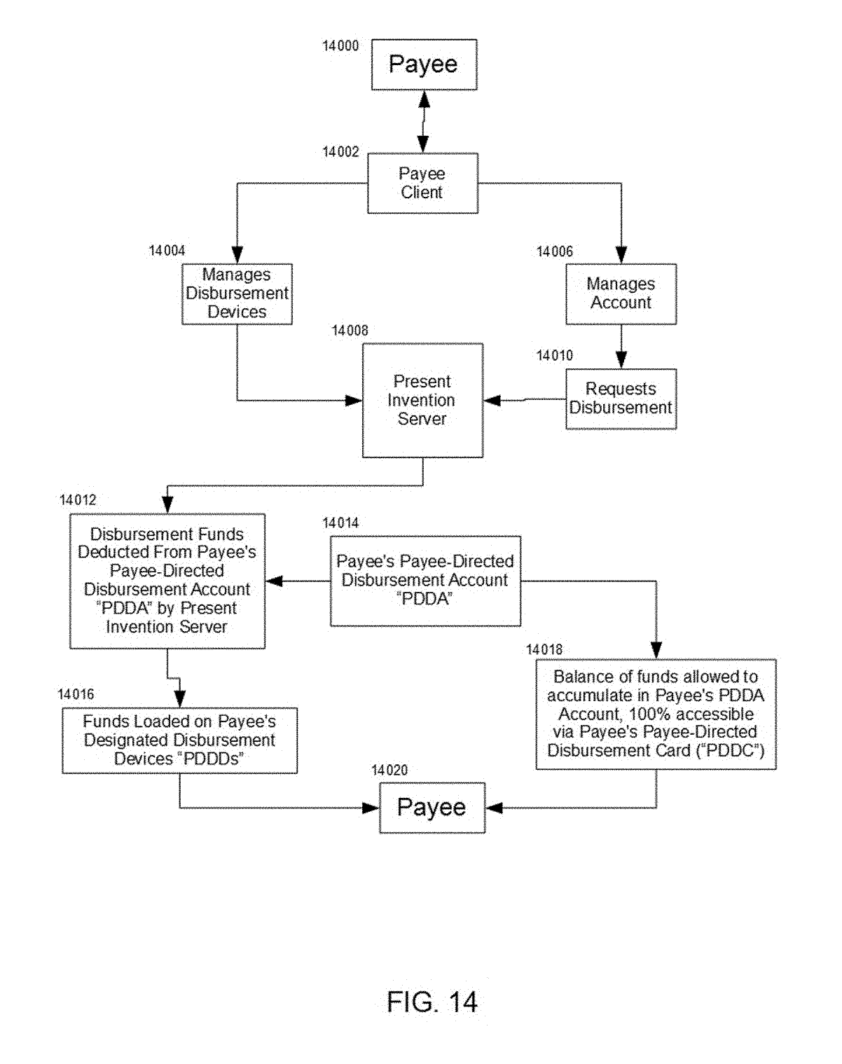

Embodiments shown in FIGS. 1-13 primarily illustrate systems/mechanisms having to do with the Present Invention's facilitation of PAYER'S side of the Payment Event transactions and loading of a Payer's-Controlled Pay Account preparatory to having funds distributed to Payees according to Payer's Payment Manifest in a transaction hereinafter referred to as a “Payment Event”. Embodiments in FIGS. 14-26 illustrate systems/mechanisms having to do with the PAYEE'S self-direction and disbursement of the Payment Event proceeds. Present Invention and its Systems will be described by illustrations or examples that in no way limit the functionality to the specific examples given while similar references within the illustrations denote similar elements. Further, illustrations, though shown mostly sequentially for numbering purposes, may have one or more of the functionalities or modalities being represented that do not necessarily occur in sequential or consecutive order and may, in fact, take place simultaneously or within milliseconds of another. Similar references within the illustrations denote similar elements in which:

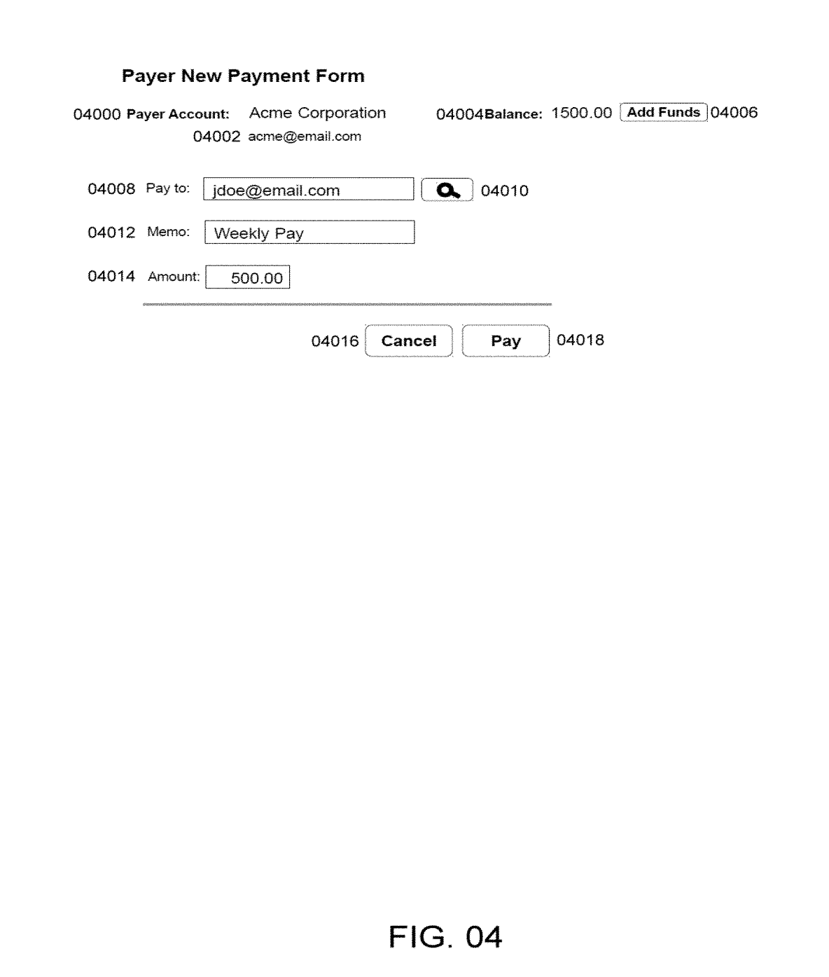

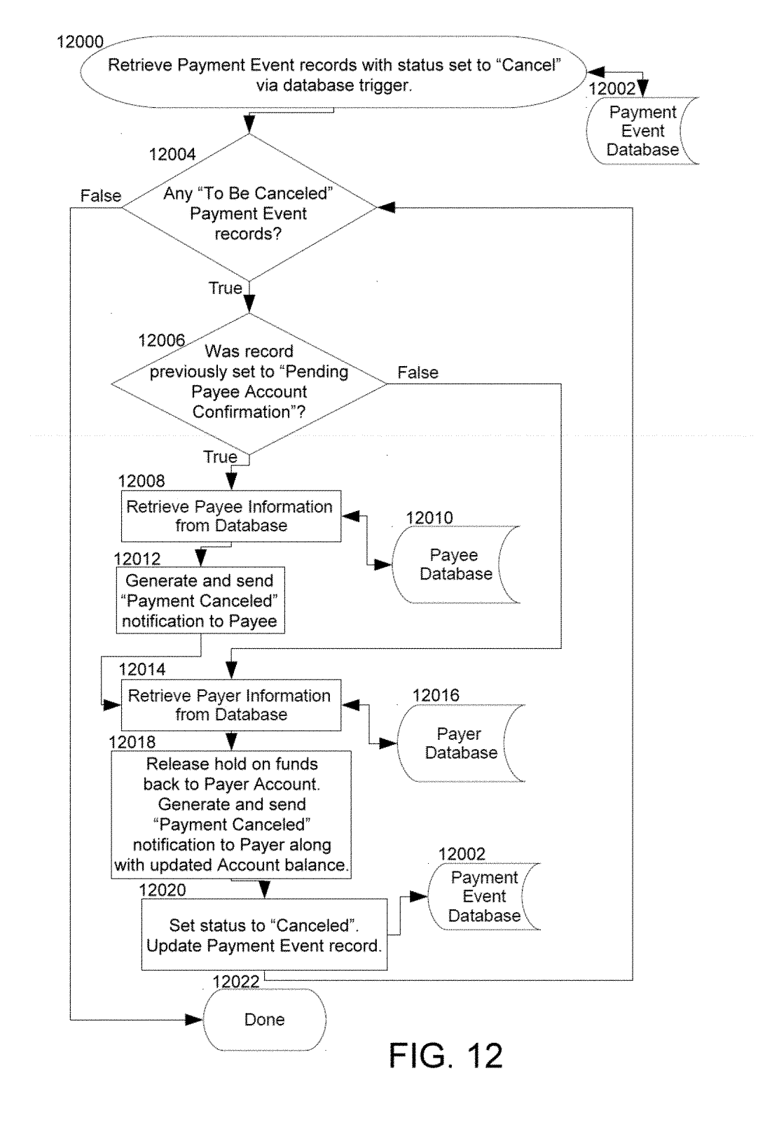

FIG. 1 (elements 01000-01020) is a simplified overview flowchart of the Present Invention which represents alternative methods for the flow of compensation from Payer through a client/server system and the basic steps of the mechanism whereby Payee takes direct control over the disbursement of said compensation without disclosure of private financial information to Payer or the risk of possible loss of same and ensuing potential damage for such loss for having so disclosed. 01000 represents any Payer of Compensation, be it for goods or in any way for hire.—NOTE: It is presupposed that all bookkeeping, accounting, and reporting of or for whatever activities, services, or goods rendered to or on behalf of Payer which have created Payer's indebtedness to Payee have already been handled by Payer or on Payer's behalf and are therefore not part of the present invention or its illustrations.—Payer 01000 is directly connected to the Present Invention's System through 01004, which, in a two-tiered network architecture, as anyone skilled in the art will recognize, functions as a Client or remote input device for the Payer, and which client includes a Payer's User Interface provided by present invention's service provider and Present Invention's Server 01010. In a two-tiered network architecture, said server, as anyone skilled in the art will recognize, plays host to enabling software and receives data input from remote devices serving as clients. In this illustration, the left side of the flowchart from Payer 01000 up to and including the Present Invention Server 01010 represents the mechanism by which instructions are generated that result in the flow of necessary information to Present Invention Server 01010 via 01006, whereby Payer transmits a Payment Manifest record for each designated Payee, along with a command trigger to pay said Payee(s) upon Present Invention Server's receipt of notification of deposit of sufficient funds to effect a particular Payment Event. The right side of the flowchart from Payer 01000 up to and including the Present Invention Server 01010 represents the flow of sufficient funds to Payer's Payer-Controlled Pay Account (“PCPA”) to accomplish said compensation Payment Event. Payee may issue funds 01002 via a bank wire or ACH transfer from Payer's operating account to a PCPA 01012. As an alternative to a bank wire or ACH transfer, the Payer 01000 can, through the Payer's Client 01004, use a Payer Merchant Account 01008 with which to fund a compensation Payment Event where funds are credited to Payer's PCPA 01012. Once sufficient funds are tracked by and reported to Present Invention Server 01010 as having been credited to Payer's PCPA 01012, said Server takes over the execution of a compensation Payment Event whereby said compensation funds are discretely credited to Payee's Payee-Directed Disbursement Account (“PDDA”) 01014. Except as noted elsewhere [see FIGS. 4 and 12, re “cancelled”], once funds have been deducted from Payer's PCPA 01012 and forwarded by instructions generated by Present Invention Server 01010 to Payee's Payee-Directed Disbursement Account 01014, Payer's liability to Payee ceases, and no specific information as to Payee's use or disbursement of received funds is available to Payer. From said PDDA 01014, funds are 100% immediately available to Payee 01020 through one or more Payee-Directed Disbursement Cards (“PDDCs”) 01016 issued to the respective Payees and linked to their PDDAs. (PDDCs will most often be private labeled either branded to the Present Invention's System or branded to the compensation Payer.) Any percentage or designated amount of such funds in the Payees' PDDAs not accessed directly via their PDDCs can be designated and disbursed directly by Payees to any of Payees' Payee-Directed Disbursement Devices (“PDDDs”) 01018. Such devices include, but are not necessarily limited to, direct deposit(s) to one or more bank accounts, paper/e-checks, money orders, and virtually any kind, number, and combination of verifiably legitimate debit, credit, gas, phone, gift, or store cards, prioritized, among others, by card, card type, and dollar amounts at Payee's directions received prior to or at anytime after a specific Payment Event.

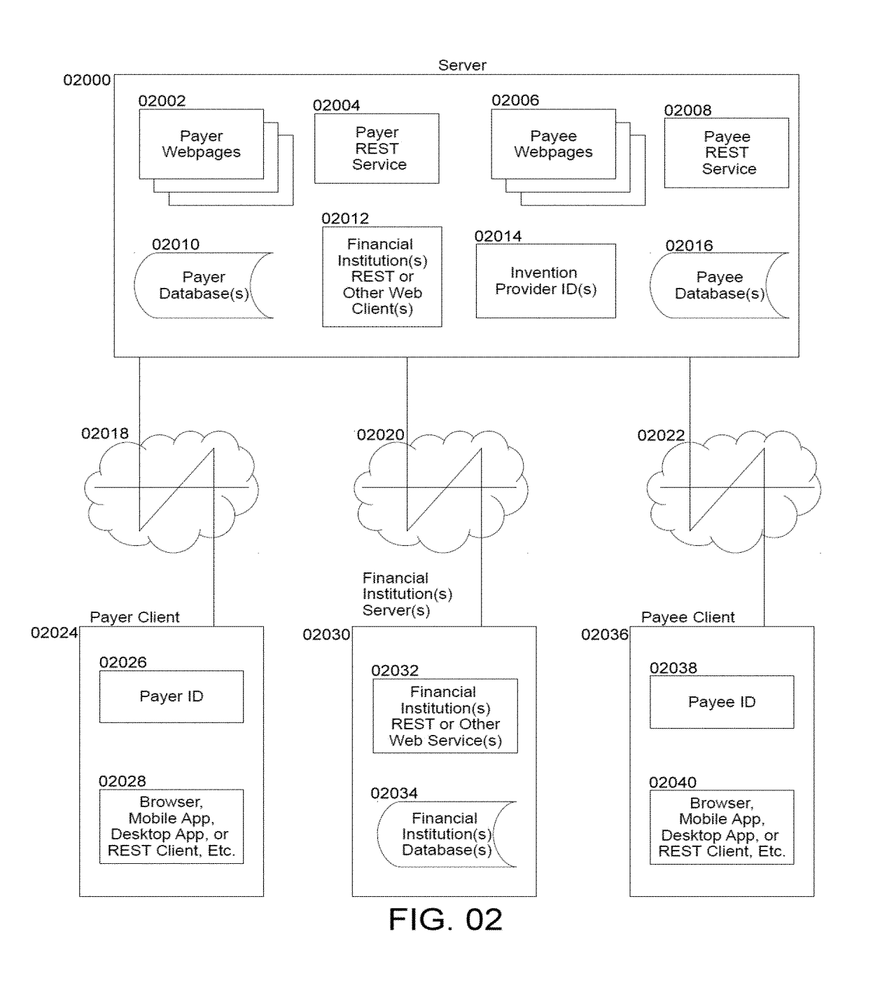

FIG. 2 (02000-02036) is a diagram illustrating various elements of the Present Invention's Server System which facilitate the flow of compensation from the Payer to the disbursement control and possession of the Payee. Besides controlling and enabling software, 02000 represents at minimum eight elements (02002-02016) that are part of the Present Invention Server System, whether resident on or mirrored by said Server. 02002 represents Payer's Webpages, comprised, among others, of the Payer Client User Interface. 02002 may also include or be referred to as Payer's “BackOffice” or “Dashboard”, whereby Payer interacts with Present Invention's Server to initiate and facilitate the use of said Server to privately and efficiently move compensation from Payer to Payees. 02010 represents the Payer Database where Payer-sourced and/or related information critical to the paying of compensation is stored and retrieved. 02004 represents the Payer-centric REST Service. Those skilled in the art will recognize the importance of multiple APIs which conform to specific web architectural standards for the parsing of information separate and independent from other APIs handling data triggers and listeners. The REST service interacts with both web based services and mobile applications to facilitate the present invention's compensation fulfillment functionalities on behalf of the Payers. 02012 represents bank or financial institution-centric REST Service(s) or other web client(s). Those skilled in the art will recognize the importance of multiple APIs which conform to specific web architectural standards for the parsing of information separate and independent from other APIs handling data triggers and listeners. The bank/financial institution(s) REST service(s) interact(s) with both web based services and mobile applications to facilitate the present invention's compensation fulfillment functionalities as they relate to specific bank(s) or financial institution(s) participant in the transaction(s). 02006 represents Payee's Webpages, comprised, among others, of the Payee Client Interface. 02006 may also include or be referred to as Payee's “BackOffice” or “Dashboard”, whereby Payee interacts with Present Invention's Server to privately and efficiently orchestrate the flow of compensation from Payer to Payees. 02016 represents the Payee Database where Payee-sourced and/or related information critical to the receiving and self-directed disbursement of Payees' compensation is stored and retrieved. 02008 represents the Payee-centric REST Service. The Payees' REST services interact with both web based services and mobile applications to facilitate the present invention's compensation fulfillment functionalities on behalf of the Payees. 02014 represents Invention Provider's ID(s)/credentials, comprised of one or more highly secure identifiers issued by either the Provider, the financial institution(s), or both, that allow the present invention to carry out its compensation fulfillment modalities in a secure environment. 02018, 02020, and 02022 represent the internet and/or network, or “cloud” connection(s) by which the parties to the Present Invention's Pay Processing Clients and Server(s) connect and communicate among themselves. 02024 represents the Payer Client, comprised at minimum of 02026, Payer ID/credential, and 02028, Payer Browser, Mobile App, Desktop App, or REST Client, etc. 02030 represents the Bank(s)/Financial Institution(s) Server(s), comprised at minimum of 02032 Financial Institution(s) REST or other Web Service(s), and 02034, Financial Institution(s)' Database(s). 02036 represents the Payee Client, comprised at minimum of 02038, Payee ID/credential, and 02040, Payee Browser, Mobile App, Desktop App, or REST Client, etc.

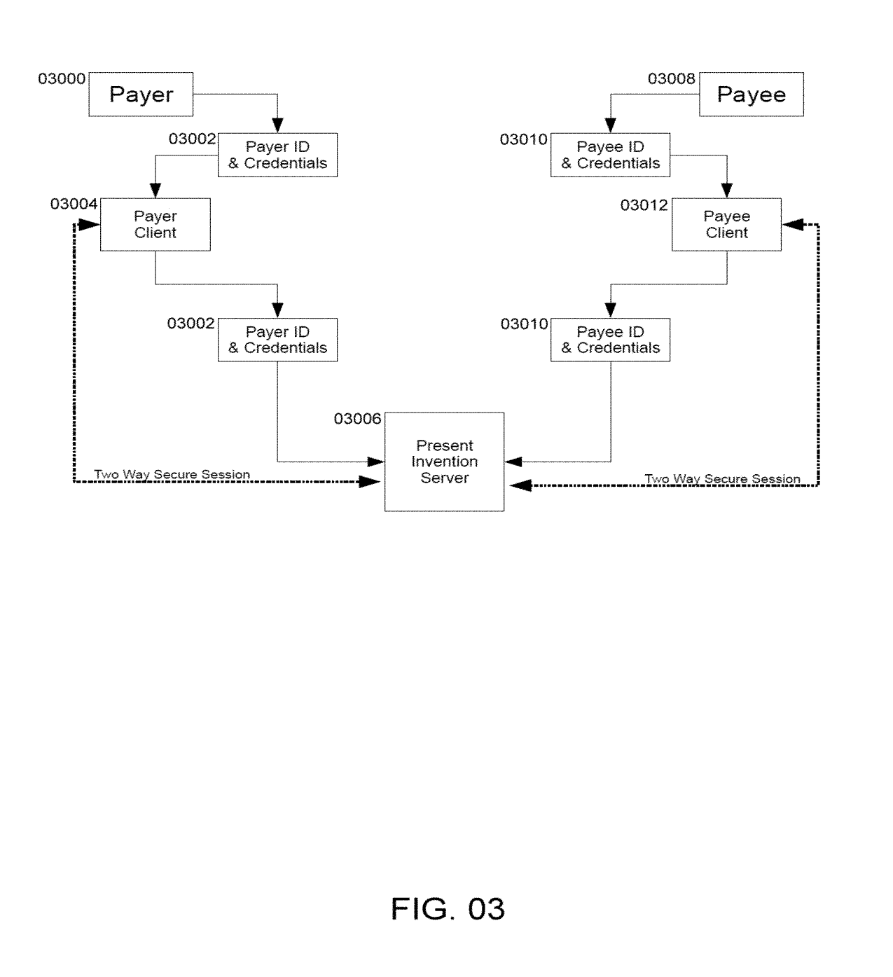

FIG. 3 (elements 03000-03012) is a flowchart illustrating the present invention's sign-in and verification steps for Payers and Payees when interacting with the Present Invention's Server. 03000 represents any enrolled Payer of Compensation inputting 003002 Payer's ID/credentials into 03004, Payer's client, which in turn relays Payer's ID/credentials 03002 to 03006, Present Invention's Server, where said ID/credentials are matched with data within said Present Invention Server via a two-way Secure Session to allow or block access to the Present Invention's System. 03008 represents any enrolled Payee of Compensation inputting 003010 Payee's ID/credentials into 03012, Payee's client, which in turn relays Payer's ID/credentials 03010 to 03006, Present Invention's Server, where said ID/credentials are matched with data within said Present Invention Server via a two-way Secure Session to allow or block access to the Present Invention's System.

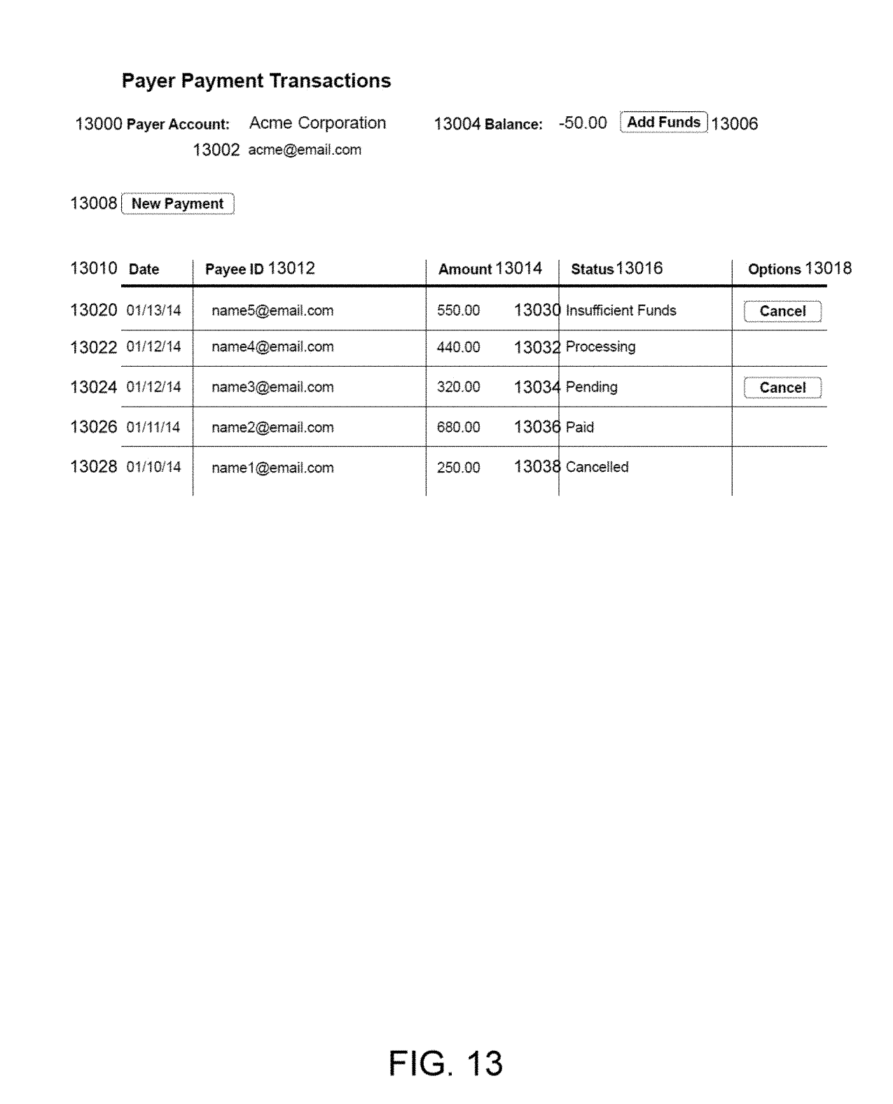

FIG. 4 (elements 04000-04018) illustrates what the online Payer New Payment Form (accessible to Payer via Payer's client) might look like whereby a compensation Payer identifies a Payee and designates a compensation amount to be paid to same for a new Payment Event. 04000 identifies the registered name of the compensation Payer and includes 04002 the Payer's login email address. 04004 reflects the total balance in the Payer's Payer-Controlled Pay Account “PCPA” at the time the New Payment Form is initiated. A link is provided 04006 to allow Payer to Add Funds to the PCPA, should there be insufficient funds in that account to cover the newly entered Payment Event name and compensation amount to be paid. The name of the designated Payee is entered at 04008, most often indicated by Payee's officially registered email address. Payee's name may auto populate or a pull-down menu may appear as name is being typed. A search feature 04010 may also be used to facilitate the entering of a designated Payee's name. A memo space 04012 is provided by which to identify the purpose of the Payment Event, i.e., weekly/hourly pay, salary, commissions, bonuses, purchases, etc. In the space for “Amount” 04014, a figure may auto populate based upon Payer's input preferences and/or information stored in and retrieved from Payer's database or the space may be blank Whether auto-populated or appearing as blank, any amount manually entered in this blank will override any previous figure that might show up. (Some iterations of the Payer's New Payer Form may include calculators for items such as numbers of hours worked, rate per hour or unit, etc., to help facilitate calculation of compensation amounts.) Either at the time of filling out the New Payment Form or any time prior to receiving notification from the Present Invention's System that the Payment Event has been completed, Payer has the option of cancelling the individual Payment Event by clicking the “Cancel” button 04016, having the same effect as any Payer would who exercised the option of a “Stop Payment” on an issued check that had yet to be cashed. [See FIGS. 12, 13.] When Payer is satisfied that the New Payment Form is completed correctly, clicking “Pay” 04018 closes the current window for the form and forwards the new information to Present Invention's Server for processing. Simultaneously, the balance figure at 04002 will reflect a deduction of the amount in 04014, which new balance will show the next time the New Payment Form is accessed.

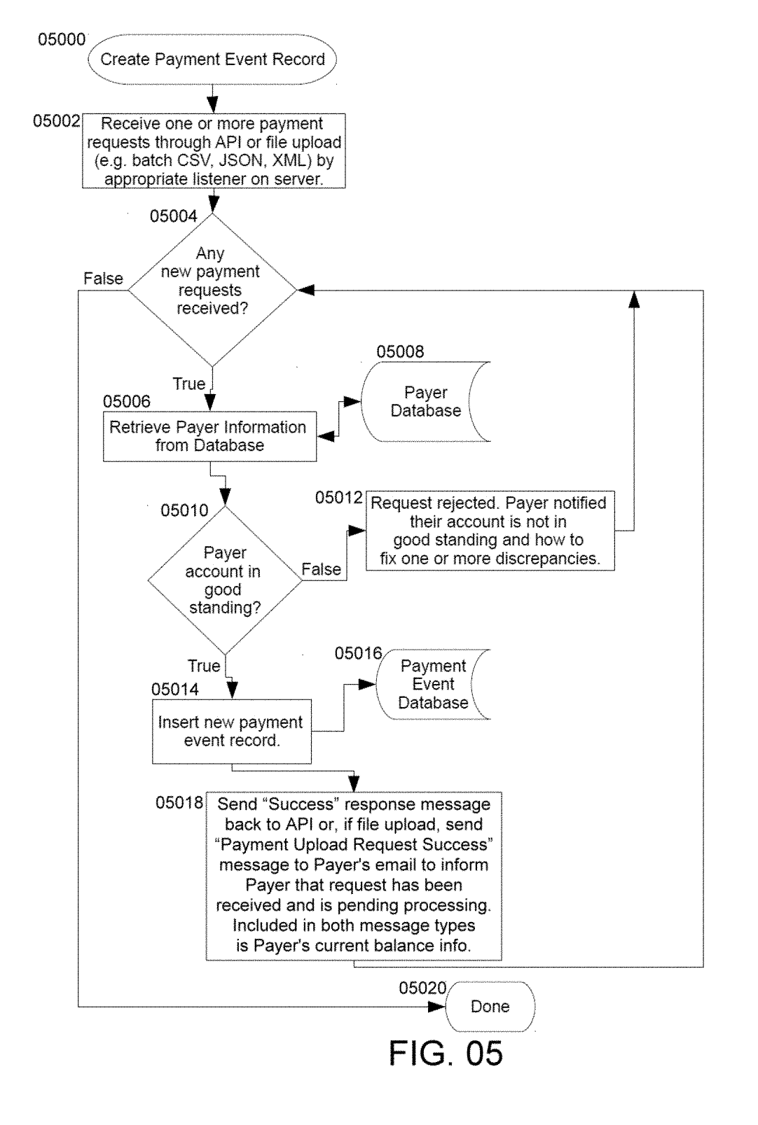

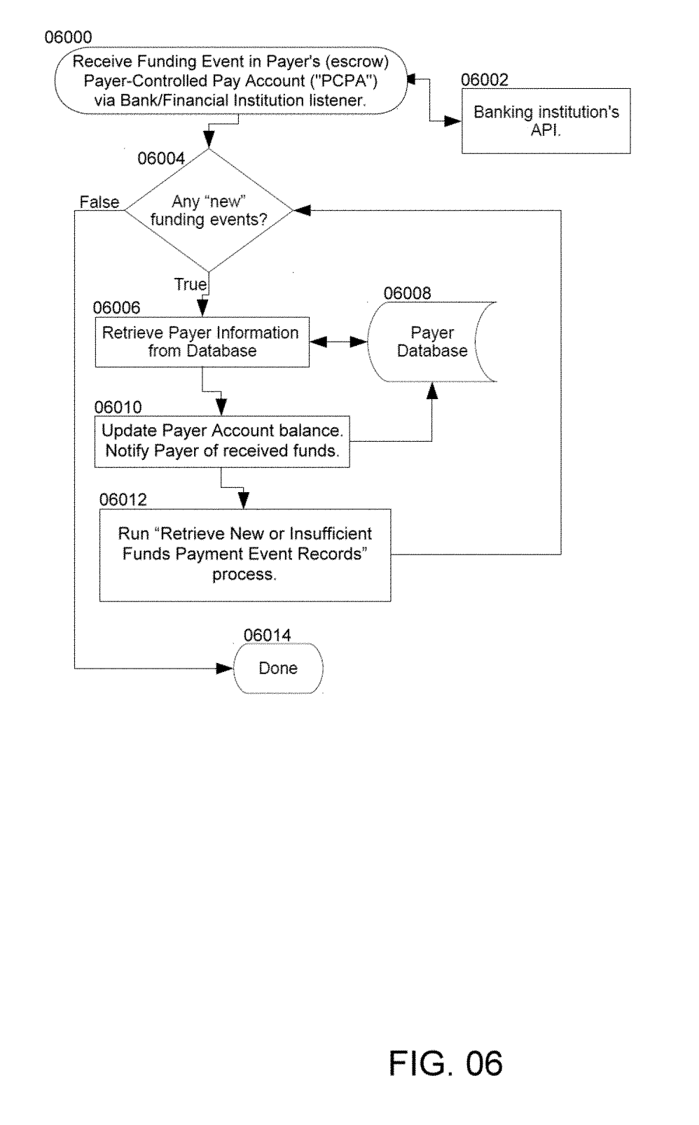

FIG. 5 (elements 05000-05020) is a flowchart that illustrates the steps handled by the Present Invention's System whereby a Payer of compensation triggers the creation of a Payment Event Record. By virtue of activity on the Payer's Client Interface, notification of flow of funds and the generation and forwarding of a Payment Manifest trigger the creation of a Payment Event Record 05000), which activity is received 05002 internally to the Present Invention's Server as one or more payout requests through API or file upload (e.g., batch CSV, JSON, XML) by appropriate listener on server. Software query 05004 asks for any new payment requests that have been received. If the answer is False, the System passes the data on to the next listener and query 05020 [see FIG. 6] and will continue to query for new payment requests 05004 until one is found to process. If the answer to 05004 is True, System retrieves 05006 Payer information from 05008 Payer Database and sends partially processed record to query 05010 which asks whether Payer's Payer-Controlled Pay Account (“PCPA”) is in good standing. Any negative result from query 05010 results in a request rejection 05012 where Payer is notified that Payer's Payer-Controlled Pay Account is not in good standing and offers suggestions to Payer as to how to correct whatever deficiencies have caused the request rejection. The Present Invention's System then cycles back to query 05004 to await new information and updates. If query 05010 is True, (PCPA is in good standing), System 05014 inserts new Payment Event Record into 05016 Payment Event Database and into the System's fulfillment stream at 05018, at which point the System sends “Success” response message back to API. Or, if file upload, the System will send “Payment Upload Request Success” message to Payer's email to inform Payer that the request has been received and is pending processing. Included in both message types is Payer's current balance info. After, the System cycles back to the query at 05004, looking for any new received pay requests. If none found, the System passes the data on to the next listener and query 05020 [see FIG. 6] and will continue to query for new payment requests 05004 until one is found to process.

FIG. 6 (elements 06000-06014) is a flowchart illustrating how the Present Invention's System receives electronic notification from a bank or financial institution of a Funding Event, via bank or financial institution's API, and handles said funds in a Payer's (escrow) Payer-Controlled Payout Account. A Payer of compensation, with or with out an accompanying Pay Request (via the online Payer New Payment Form (as in FIG. 4) or in a batch upload of a Payment Manifest, may at any time initiate a payment of funds from Payer's operating (or other) account to Payer's Payer-Controlled Pay Account (“PCPA”) in order to cover the costs of such a Payment Event. The Present Invention's System 06000 listens for and responds upon receiving an API notification 06002 from a correspondent Bank or Financial Institution any time there is such a funds transfer (“Funding Event”). The system responds via a query/listener constantly asking for any “new” Funding Events. If the answer is False, the System terminates the then current query 06014. If, however, the response to the then current 06004 query is True, the System 06006 stores/retrieves Payer Information from 06008 Payer Database and updates 06010 Payer's PCPA balance and notifies Payer that funds have been received and added to the previous balance of funds. This in turn triggers the System 06012 to run the “Retrieve New or Insufficient Funds Payment Event Records” process. Upon completion of said process, System again runs 06004 query for any “New” Funding Events.

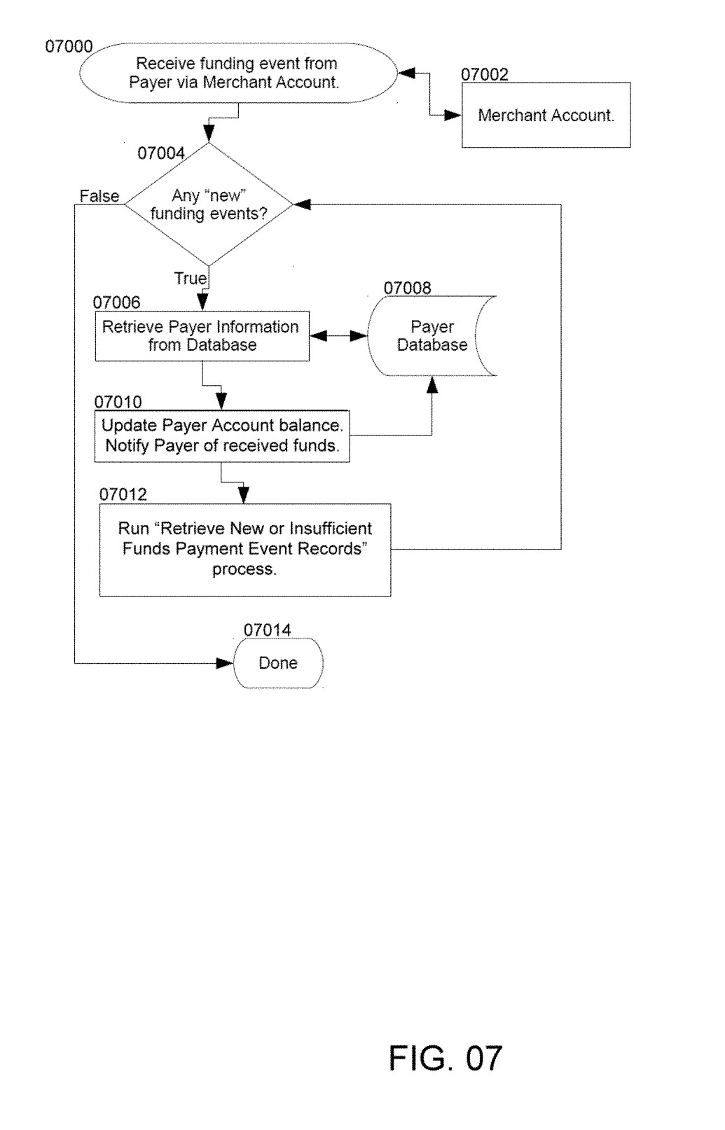

FIG. 7 (elements 07000-07014) is a flowchart illustrating how the Present Invention's System receives electronic notification from a bank or financial institution of a Funding Event, via merchant account, and handles said funds in a Payer's escrow Pay Account (Payer-Controlled Pay Account—“PCPA”). A Payer of compensation, with or with out an accompanying Pay Request (via the online Payer New Payment Form (as in FIG. 4) or in a batch upload of a Payment Manifest, may at any time initiate a payment of funds from Payer's operating (or other) account to Payer's Payer-Controlled Pay Account (“PCPA”) in order to cover the costs of an upcoming Payment Event. The Present Invention's System 07000 listens for and responds upon receiving an API notification 07002 from a bank/financial institution API or a Merchant Account Gateway any time there is such a funds transfer by means of Payer's credit or debit card. The system responds via a query/listener constantly asking for any “new” Funding Events. If the answer is False, the System terminates the then current query 07014. If, however, the response to the then current 07004 query is True, the System 07006 stores/retrieves Payer Information from 07008 Payer Database and updates 07010 PCPA balance and notifies Payer that funds have been received and added to the previous balance of funds. This in turn triggers the System 07012 to run the “Retrieve New or Insufficient Funds Payment Event Records” process. Upon completion of said process, System again runs 07004 query for any “New” Funding Events.

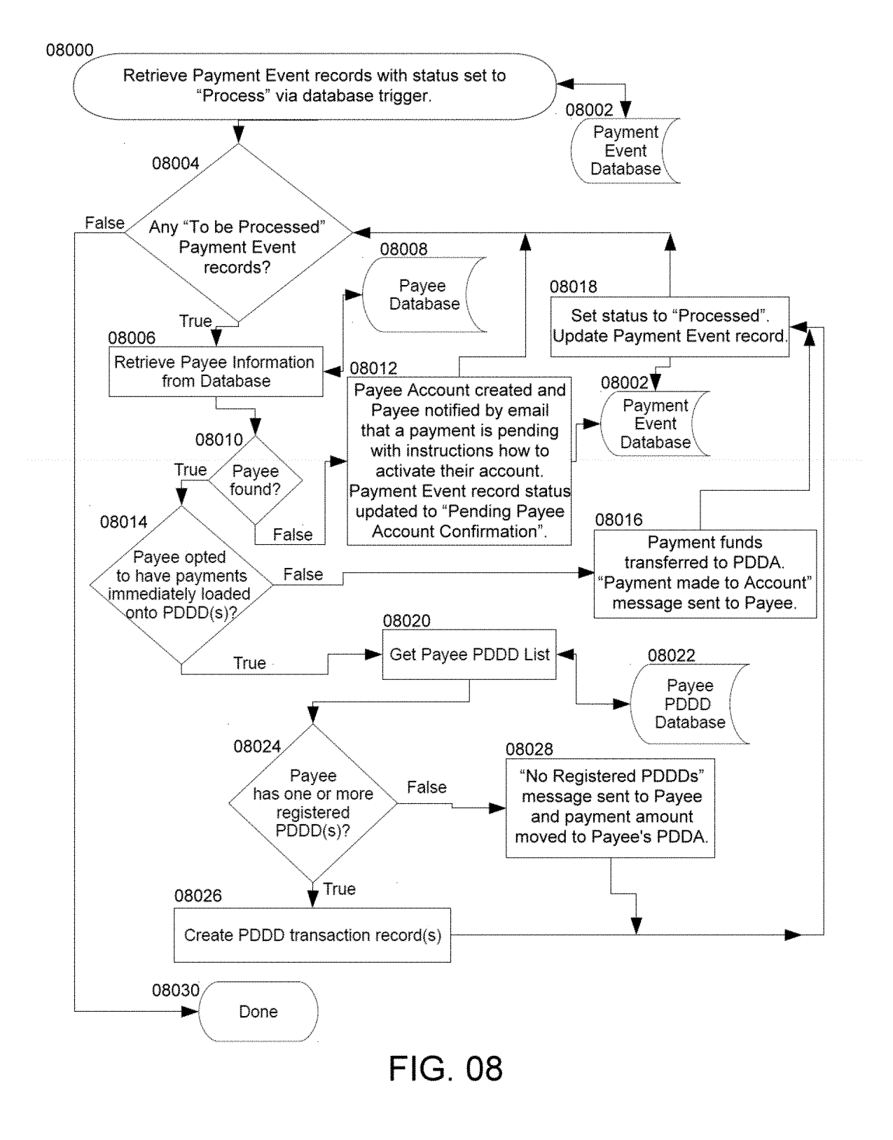

FIG. 8 (elements 08000-08030) is a flowchart illustrating the multi-query process by which the Present Invention's System retrieves, via one or more database triggers, and handles updated Payment Event records with status set to “Process”. Present Invention's System 08000 retrieves Payment Event records with status set to “Process” by way of database trigger from 08002 Payment Event Database. Having received database trigger, the System queries 08004 for any “To Be Processed” Payment Event Records”. If the answer to the query is False, System terminates the then current query 08030 and continues to listen for new database triggers. If the 08004 query is True, System retrieves 08006 Payee Information from 08008 Payee Database and issues another query 08010 regarding whether or not Payee named in Payment Event Record was found in the Payee Database, where “found” relates to a current and completed Payee profile, including Pay Disbursement preferences. If named Payee is not “found” (a returned False), System creates a skeleton or shell Payee-Directed Disbursement Account and notifies Payee's email (retrieved from Payment Manifest from Payer) that a Payment is pending, with instructions how Payee is to confirm and activate his or her account. Payment Event record status for that Payee is updated in the 08002 Payment Event Database to “Pending Payee Account Confirmation”. System returns to query at 08004, looking for any “To Be Processed” Payment Event records. If 08010 “Payee Found?” query is returned True, query 08014 looks for information regarding whether or not the named and identified Payee has opted to have Payment Event proceeds immediately loaded onto one or more Payee Directed Disbursement Devices (“PDDDs”). If the return to the 08014 query is False, System transfers 08016 100% of Payment Event funds into Payee's Payee-Directed Disbursement Account and sends “Payment Made to Account” message to Payee. 08018 sets status to “Processed” and update is made to Payment Event Record in the 08002 Payment Event Database. System returns to query 08004, looking for any “To Be Processed” Payment Event records. If 08014 query regarding Payee's opting to have payments immediately loaded onto PDDDs is returned True, System 08020 gets Payee PDDD List from 08022 Payee PDDD Database and queries 08024 whether Payee has one or more registered PDDDs. If query is returned False, message 08028 “No Registered PDDDs is sent to Payee, payment amount is moved to Payee's PDDA, 08018 sets status to “Processed”, update is made to Payment Event Record in the 08002 Payment Event Database, and System returns to query 08004, looking for any “To Be Processed” Payment Event records. If query 08024 is returned True, 08026 creates PDDD transaction record(s), 08018 sets status to “Processed”, update is made to Payment Event record in the 08002 Payment Event Database, and System returns to query 08004, looking for any “To Be Processed” Payment Event records.

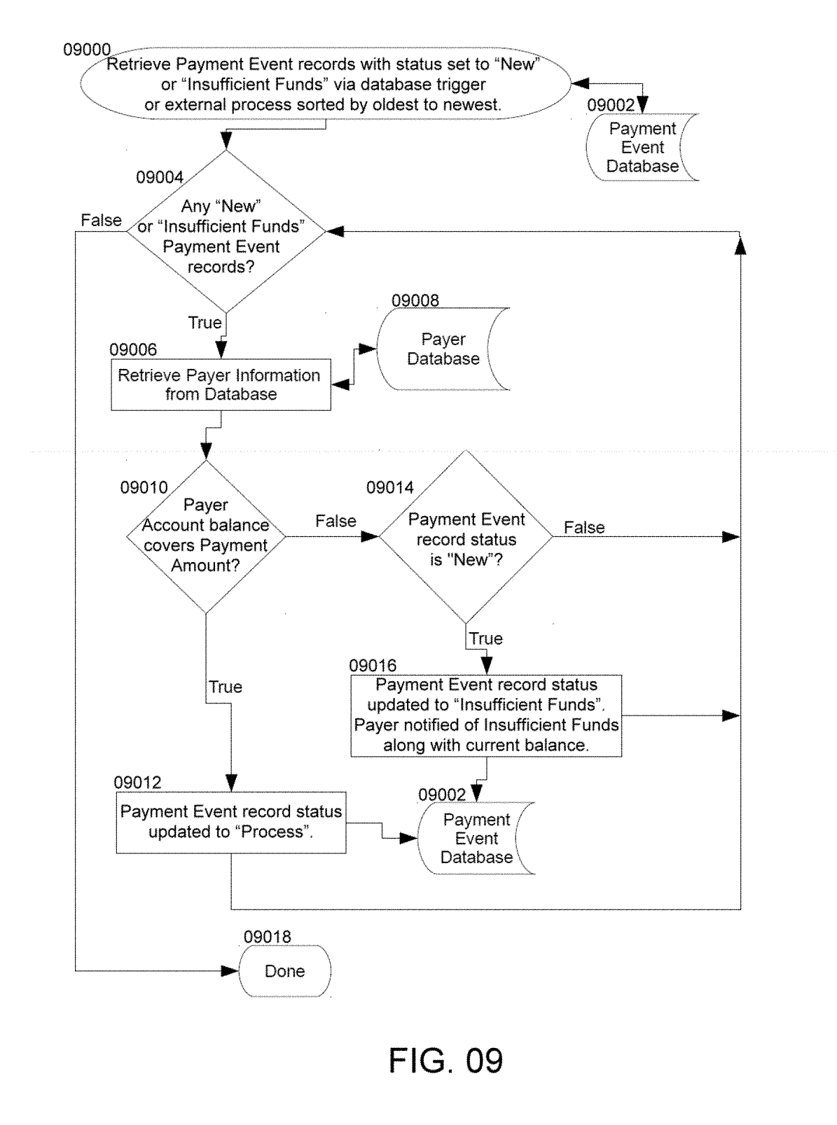

FIG. 9 (elements 09000-09018) is a flowchart illustrating how the Present Invention's System retrieves, via database trigger or external process, and handles Payment Event records with status set to “New” or Insufficient Funds” sorted by oldest to newest. Present Invention System 09000 searches Payment Event records from 09002 Payment Event Database. Present Invention's System 09000 retrieves Payment Event records with status set to “New” or Insufficient Funds” by way of database trigger from 09002 Payment Event Database. Having received database trigger, the System queries 09004 for any “New” or Insufficient Funds” Payment Event Records”. If the 09004 query is returned True, System retrieves 09006 Payer Information from 09008 Payer Database and issues another query 09010 regarding whether or not Payer-Controlled Pay Account has a balance sufficient to cover pending Payment Event Amount. If the balance is not enough, query returns a False which triggers an additional query 09014 to ascertain whether or not Payment Event Record status is “New”. A return of “False” (meaning record is not New) sends System back to query 09004, searching for “New” and “Insufficient Funds” Payment Event records. If query 09014 returns as True (meaning current Payment Event record IS New), System 09016 updates Payment Event record status (in 09002 Payment Event Database) to “Insufficient Funds”, and Payer is notified of Insufficient Funds status for current/pending Payment Event with the latest amount currently showing in Payer-Controlled Pay Account, and System returns to query 09004, looking for “New” and “Insufficient Funds” Payment Event records. If query 09010 regarding whether Payer Account (PCPA) has a balance sufficient to cover current pending Payment Event returns as True, 09012 updates the Payment Event record status to “Process” in the 09002 Payment Event Database, and System recycles back to query 09004, looking for “New” and “Insufficient Funds” Payment Event records.

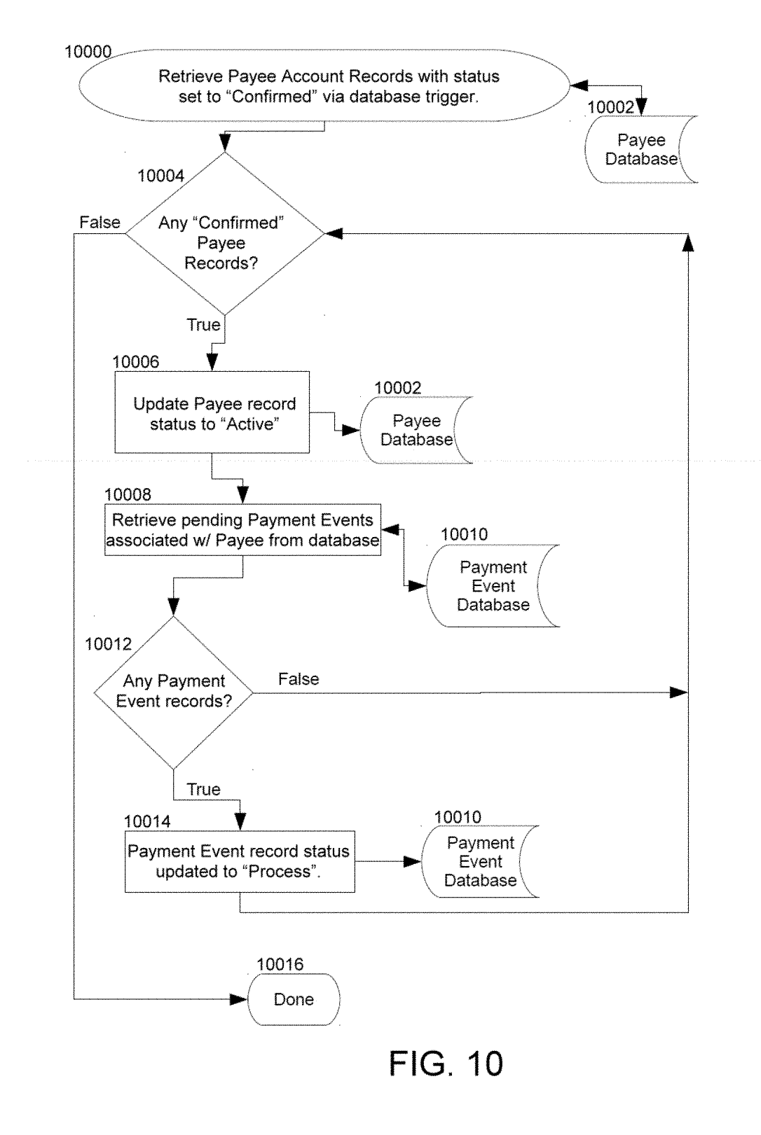

FIG. 10 (elements 10000-10020) is a flowchart illustrating how the Present Invention tracks and updates the records of a Payee who has been allocated compensation but does not have an active Payee-Directed Disbursement Account and works with said Payee to achieve a “Confirmed” and “Active” status. Present Invention's System is designed to facilitate compensation Payment Events, seeing to it that Payees connect with their Pay in a timely manner. Should a designated Payee have funds allocated but does not have a confirmed and active account, the System is designed to set up such an account and notify the Payee as to how to make the account active. [See FIG. 08 @ 08012.] FIG. 10 illustrates the mechanism whereby such an account is updated and confirmed by Payee and turned “Active” by the System where Present Invention's System 10000 searches Payment Event records from 10002 Payee Database. Then, System queries 10004 for any “Confirmed” Payee records. (Payees confirm their own accounts upon completing their online Payee Profiles and clicking “Confirm”.) If the answer to the query returns as False, System terminates the then current query 10016 and continues to listen for new database triggers. If the 10004 query is returned as True, System updates Payee record status to “Active” and writes updated record to 10002 Payee Database. Then System retrieves 10008 Pending Payment Events associated with Payee from 1002 Payee Database and queries 10012 for any Payment Event records. If 10012 query returns False (meaning there are no Payment Event records), System reverts back to query 10004, looking for any “Confirmed” Payee records. If query 10012 regarding any Payment Event records returns as True, System 10014 updates Payment Event Record status (in 10010 Payment Event Database) to “Process”, and System returns to query 10004, looking for any “Confirmed” Payee records.

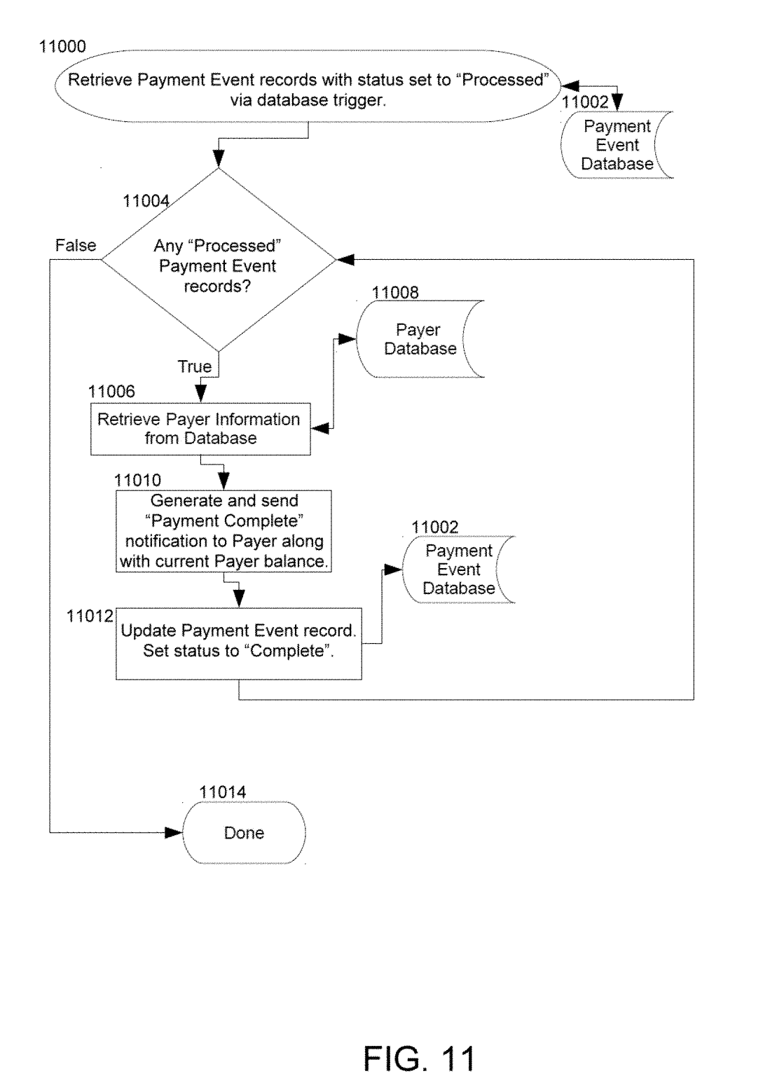

FIG. 11 (elements 11000-11014) is a flowchart illustrating how the Present Invention's System retrieves Payment Event records with status set to “Processed” via database trigger. Present Invention's System 11000 retrieves Payment Event records with status set to “Processed” by way of database trigger from 11002 Payment Event Database. Having received database trigger, the System queries 11004 for any “ Processed” Payment Event Records”. If the answer to the query returns as False, System terminates the then current query 11014 and continues to listen for new database triggers. If the 11004 query is returned as True, 11006 System retrieves Payer Information from 11008 Payer Database, 11010 generates and sends “Payment Complete” notification to Payer (along with current balance in Payer's Payer-Controlled Pay Account, 11012 sets status to “Complete” and updates Payment Event record in 11002 Payment Event Database, and cycles back to query 11004, looking for any “Processed” Payment Event records.

FIG. 12 (elements 12000-12022) is a flowchart illustrating how the Present Invention's System retrieves and handles Payment Event records with status set to “Cancel” via database trigger. Any time prior to receiving notification from the Present Invention's System that the Payment Event has been processed/completed, Payer has the option of cancelling the individual Payment Event, having the same effect as any Payer would who exercised the option of a “Stop Payment” on an issued check that had yet to be cashed. FIG. 12 embodiments illustrate the mechanism by which the Present Invention's System effects the cancellation of a Payment Event as relates to any particular Payee record, where Present Invention's System 12000 retrieves certain Payment Event records with status set to “Cancel” via database trigger from 12002 Payment Event Database by query 12004 asking for any “To Be Canceled” Payment Event records. If the query returns a False, System terminates the then current query 12022 and continues to listen for new database triggers. If the 12004 query is returned as True, 11006 query ascertains whether or not that specific record was previously set to “Pending Payee Account Confirmation”, a condition where a designated Payee had not as yet completely filled out Payee's Payer-Directed Disbursement Account registration, marking the form “confirmed”, and having the System set the Payee's status to “Active”. If the query 12006 returns as False (meaning that Payee is already registered as confirmed and active in the System), 12014 System retrieves Payer information from 12016 Payer Database, 12018 releases hold on funds back to Payer's Payer-Controlled Pay Account, generates and sends “Payment Canceled” notification to Payer, along with updated Account balance, 12020 sets status to “Canceled”, and updates Payment Event Record in 12002 Payment Event Database, and cycles back to 12004 query, looking for any “To Be Canceled” Payment Event records. If the query 12006 returns as True (meaning that Payee was previously found not to have fully registered, confirmed same's account information, and been tagged as active in the System), 12008 System retrieves Payee information from 12010 Payee Database, 12012 generates and sends “Payment Canceled” notification to Payee, 12014 retrieves Payer information from 12016 Payer Database, 12018 releases hold on funds back to Payer's Payer-Controlled Pay Account, generates and sends “Payment Canceled” notification to Payer, along with updated Account balance, 12020 sets status to “Canceled”, and updates Payment Event record in 12002 Payment Event Database, and cycles back to 12004 query, looking for any “To Be Canceled” Payment Event records.

FIG. 13 (elements 13000-13038) illustrates what a typical Payer Payment Transaction Report might look like either during the course of or after completion of a Payment Event. Information for populating this form is constantly being sent from the Present Invention's Server to the Payer's client. On the form, 13000 identifies the Payer Account known by the company/entity name, and 13002 identifies the official company/entity email address. 13004 reflects the current balance at the time the Payer Payment Transaction Form is accessed on line or sent as an email or downloadable document. Clicking the “Add Funds” link 13006 opens a dialog screen whereby Payer can submit or transmit additional funds to Payer's Payer-Controlled Pay Account either by wire, or ACH transfer, or by means of a Merchant Account to cover an outstanding amount on a current Payment Event. Clicking 13008 “New Payment” links to a dialog box for creating a new Payment Event Transaction [see FIG. 04] by adding a Payee and a specific pay amount for said Payee. The FIG. 13 example shows five transactions in various stages of progression (13020-13028) through the payment process, arranged under five columns and marked as follows. Column 13010 is for the Date—for transactions are recorded in real time as they take place and are tied to the date of each transaction. In this example, the earliest transaction 13028 occurred on the 10^{th} of the month, and the latest transaction 13020 took place on the 13^{th} . Under the 13012 column, Payee IDs are displayed next to the corresponding date. Most often, and virtually without exception, Payees are referred to in a Transaction Report by their email addresses, though they may also include all or a portion of the Payees' names, depending upon Payer's preferences in setting up Payer's client interface. System Contact Emails can be private (supplied by the Payees themselves), or they can be part of a Payer's company/entity web/network. The column 13014 displays the Amount of compensation assigned to the respective Payee for the current Payment Event. Obviously, amounts differ based upon the agreements between the parties and services rendered or products supplied. The 13016 column lists the Status of each transaction. When a transaction is fully completed, “Paid” 13036 designates a fully Payer-funded and Payee-received transfer of funds from Payer to Payee's Payee-Directed Disbursement Account and/or Payer-Directed Disbursement Devices. A label of “Pending” 13034 is assigned when a Payee may not currently have confirmed his or her Payee-Directed Disbursement Account and/or Payer-Directed Disbursement Devices. The amount is placed by the Present Invention's System into an account on behalf of the Payee, and the Payee is notified as to how to Confirm the account and make it Active, thereby gaining access to the funds in that Account. A transaction receives the label of “Processing” 13032 during that short time frame (sometimes as short as a few milliseconds) when Payment Event Record is being updated and funds are being electronically moved from Payer's Payer-Controlled Pay Account to Payee's Payee-Directed Disbursement Account. A status of “Insufficient Funds” 13030 shows next to a transaction under the status column when previous transactions have used up the available funds and additional funds are needed to complete the Payment Event. Present Invention System notifies a Payer any time such deficiency occurs, giving opportunity for Payer to correct the deficit. “Cancelled” shows in the status line next to any transaction Payer has chosen to cancel by clicking the “Cancel” button (column 13018 “Options”) in the appropriate row. As noted elsewhere, Payer has the “Cancel” option (as any Payer would who was paying with a paper check and wished to Stop Payment on same) up to the moment a transaction receives a “Processing” notification in the Status column next to a transaction. The “Cancel” option would likely rarely be used and most often if an Account Status were “Pending” for an inordinate length of time or a former Payee wished a final distribution via another means. Once a transaction has been cancelled, the Amount of the earlier scheduled Payment Event is subtracted from the Pending column and re-added to the Payer's current Balance 13004.

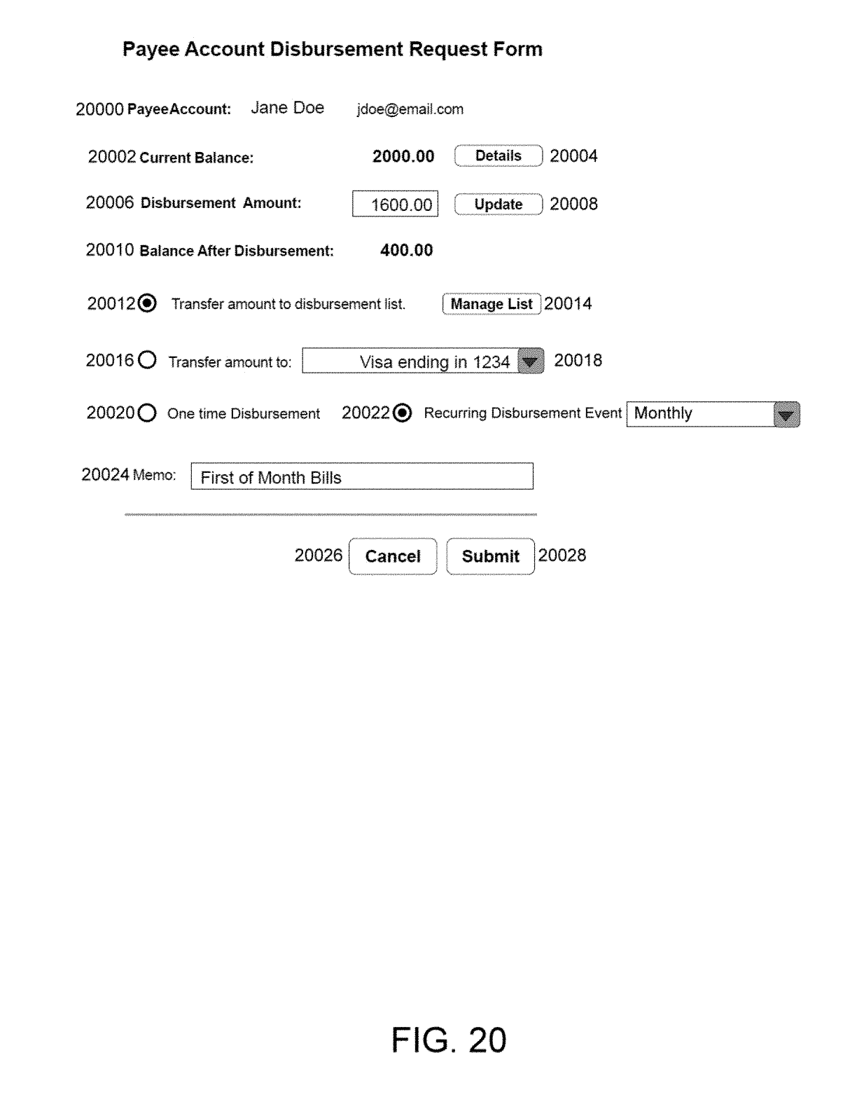

FIG. 14 (elements 14000-14020) is a simplified flowchart illustrating the basic process by which the Present Invention's System allows a Payee to take control of funds in Payee's Payee-Directed Disbursement Account. (Cf. FIG. 1.) FIG. 14 assumes that Payment Event Funds have already been received from Payer via Present Invention's System and that said funds reside in Payee's Payee-Directed Disbursement Account (“PDDA”) 14014. Payee 14000 interacts with the Present Invention through Payee Client 14002. From client, Payee manages the registration and loading preferences for Payee's Payee-Directed Disbursement Devices 14004, which registrations and preferences are communicated to Present Invention's Server 14008 for processing. Payee 14000, also via Payee's Client 14002, Manages 14006 Payee's Payee-Directed Disbursement Account (“PDDA”) 14014 by sending Disbursement Requests 14010 to Present Invention's Server 14008. [See FIG. 20.] interacts with the present invention through Payee Client 14002 from which to manage Payee's Payee-Directed Disbursement Account 14006 which requests Disbursements 14010 and sends directions to Present Invention's Server 14008. Present Invention's Server 14008 causes Requested Disbursement Funds 14012 to be deducted from Payee's PDDA 14014. Funds deducted from Payee's PDDA are sent/loaded/credited to Payee's Designated Disbursement Devices (“PDDDs”) 14016. Any funds not designated and deducted from Payee's PDDA and credited/paid out/loaded/ directly to any other PDDD are left to accumulate in Payee's PDDA, 100% accessible at any time through Payee's Payee-Directed Disbursement Card (“PDDC”) 14018. Whether through PDDDs 14016 or accumulated in Payee's PDDA, or accessed through Payee's PDDC, at all times Payment Event Funds are available to Payee to disburse/dispose of as Payee may seem fit with no risk or loss of privacy or confidentiality. [See also, FIG. 01 @ 01016.]

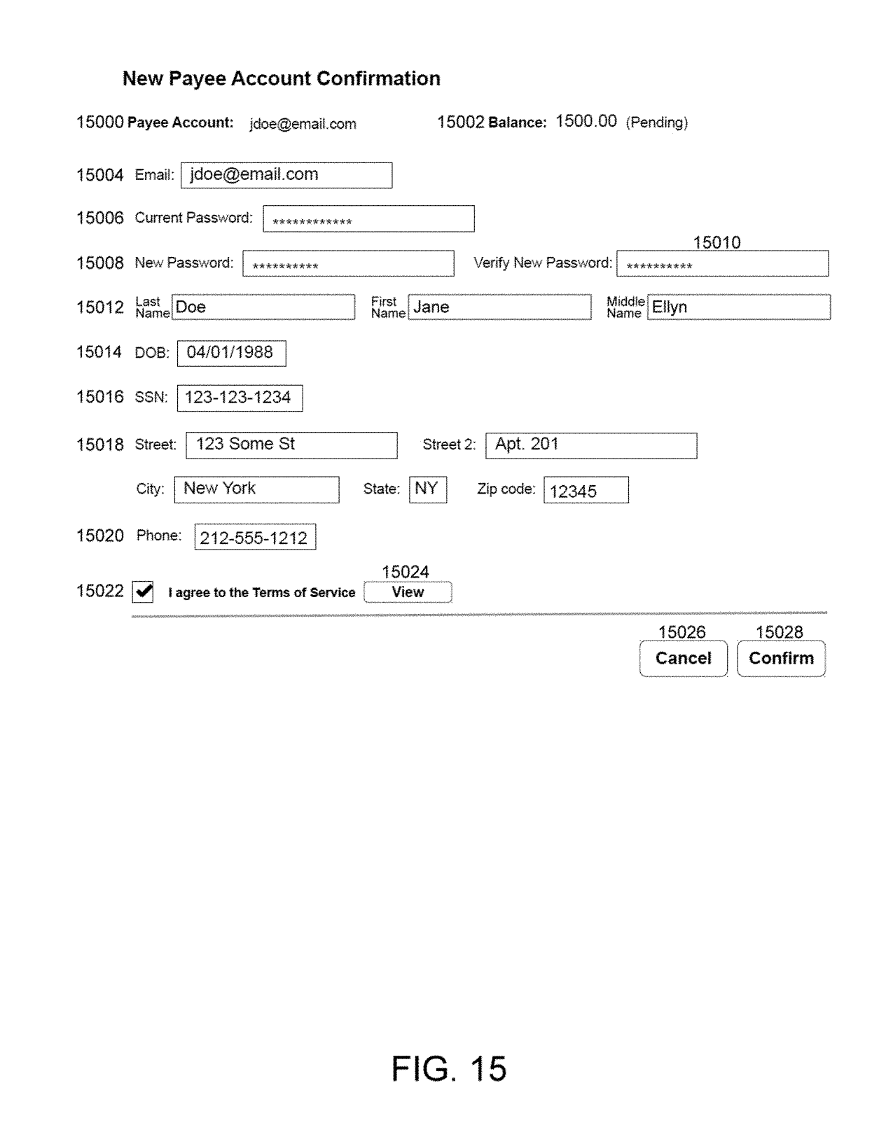

FIG. 15 (elements 15000-15028) illustrates what an online or server accessible New Payee Account Confirmation Form generated by the present invention might look like whereby a new Payee is granted access to complete the input of necessary information in order for the Payee to gain access to and take control of the Payee's User Interface. FIG. 15 represents the steps required for a Payee to register with the Present Invention in order to receive compensation at the time of a Payment Event from a Payer, said steps being represented by the fields of the illustrative form. Said form, or its equivalent, may be completed by a Payee at virtually anytime after a Payer of Compensation has contracted with Present Invention's Server System to effect transfer of payment funds from a Payment Event to one or more Payees of the Payer's entity/company. Any Payee who does not have an up-to-date active account prior to a Payment Event will have a shell or skeleton account established on such Payee's behalf at the time of a Payment Event into which account distribution of designated compensation funds are deposited, pending Payee's notification of the existence of the account and its contents and Payee's completion (“confirmation”) of the Account's identifying information. The advantage to the Payer is that obligated funds are not left on the books to become an accounting nuisance. The advantage to the Payee, even a brand new one, is the opportunity of immediate access to Payment Event Funds—with or without a Payee's access to a bank account—once the account details have been appropriately supplied and confirmed, without Payee's having to wait for a paper check to be generated and cashed or a Payroll Pay Card to be sent, received, and utilized. Payee Account 15000 is the name (typically the email address of the Payee) by which Payee is identified by the Present Invention's Payment System. Current Balance 15002 expresses the amount of compensation awaiting processing. If a new Payee's Account has not yet been confirmed by Payee's having finished supplying necessary information and confirming the New Payee Account, the balance at 15002 will show as “Pending”, as in “Pending Confirmation”. At the email field 15004, Payee will input the email address by which Payee is to receive all electronic correspondence regarding Payment Event and Pay System issues. Current Password 15006 is the password by which Payee gains system access. In the case of a new Payee, the Present Invention's System generates a temporary password which the Payee will use to access the New Payee Account Confirmation Form on the Payee Client, but Payee must change the password to one private to the Payee thereafter. 15008 allows Payee to enter a New Password, something that can be done at any time and as many times thereafter as Payee chooses, and the New Password ID verified by entering the same New Password again in the field at 15010. Payee's Last, First, and Middle Names are input in the corresponding fields at 15012. Payee's Date of Birth (“DOB”) is inserted at 15014 followed by Payee's SSN or IN at 15016. Payee's physical or mailing address is inserted in the appropriate fields at 15018 with the Payee's Phone Number at 15020. Critical to the integrity of the relationship between the parties is the agreement to the Terms of Service, which agreement is indicated by checking the box 15022 after viewing and reading the terms accessed by clicking 15024. Payee applicant may alternatively cancel the information inserted and exit the screen by clicking “Cancel” 15026. Optimally, Payee will click “Confirm” 15028, which stores the input data in the Present Invention Server's Payee Database and marks the New Payee Account as “Active”, granting Payee access to the Payee's Payee-Directed Disbursement Account, and any funds “Pending” therein are released to the Payee's control.

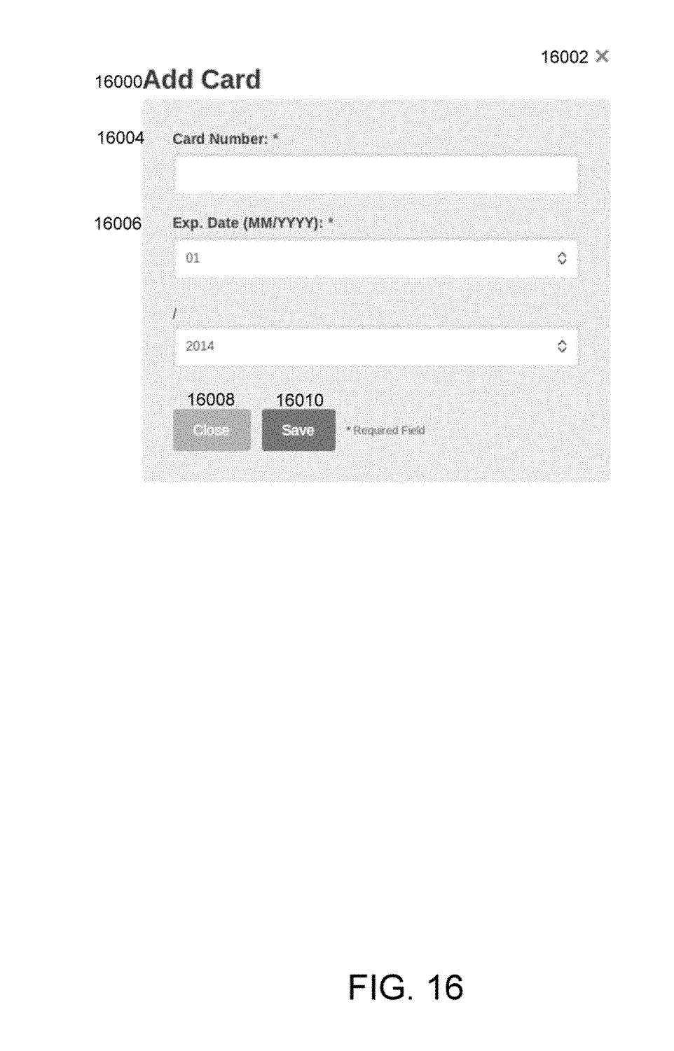

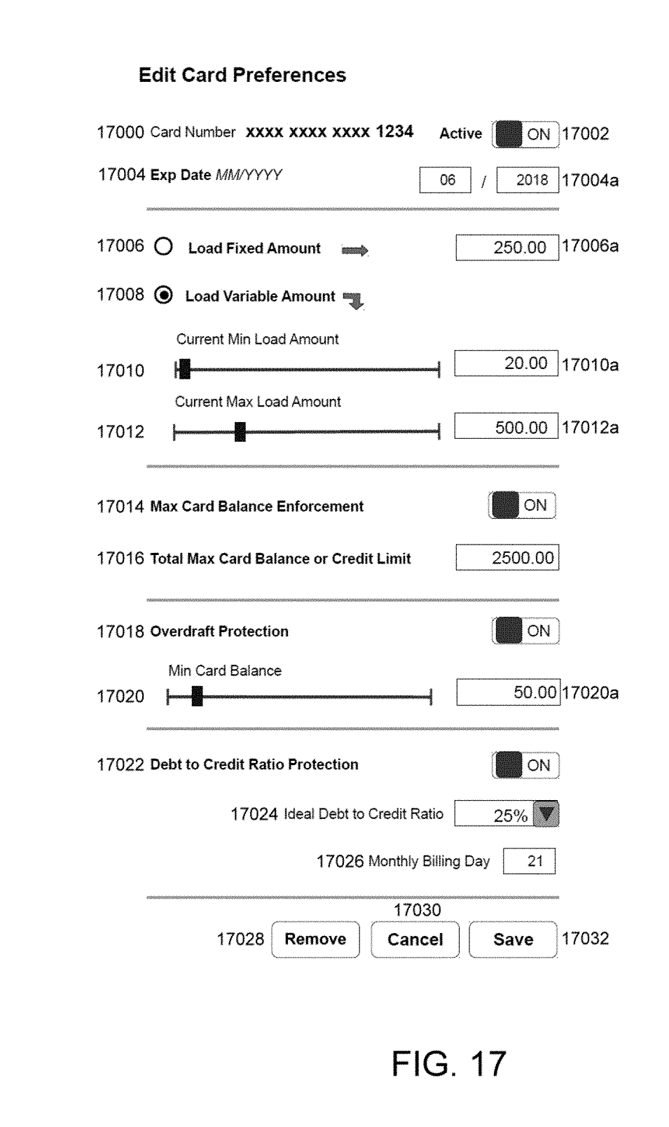

FIG. 16 (elements 16000-16010) illustrates what an interface page of the present invention looks like whereby a Payee can privately and securely add a new Payee-Directed Disbursement Device (“PDDD”), which, in this illustration, is in the form of a reloadable credit or debit card. Among the PDDD options made available for accessing Payee's funds following a Payment Event, the simplest and quickest are reloadable electronic payment cards such as debit cards, credit cards, gift cards, gas cards, phone cards, and store cards. However, in order to be eligible to receive funds directed by the Payee to such cards, each has to be entered into and registered by the Present Invention's System. [While similar forms are provided by the Present Invention's System for adding other PDDDs such as bank accounts, paper checks, e-checks, money orders, and such like, they are not shown specifically in the embodiment illustrations, as anyone skilled in the art would understand how such forms function.] The Add Card form 16000 (or its then current equivalent) starts the process. Clicking the “X” 16002 in the upper right hand corner or the “Close” button 16008 will close the Add Card dialog box without saving any information that may have been input. A card's account number can be entered in the field at 16004. Two drop-down menus at 16006 allow selection of the expiration month (01-12) in the first field and scrolling years in the lower of the two drop down menus will allow selection of an expiry year. Card Account Number and Expiration Date inputs are required to begin the card registration process which officially begins when Payee clicks “Save” 16010 and which enters the data from the Add Card Form into Payee's PDDD Database, closes the Add Card window, and opens the Edit Card Preferences window (FIG. 17). Present Invention's System immediately runs a verification process with the API of the issuing financial institution behind the added card to establish the card's validity as having been properly issued and verifying that the card can legitimately be reloaded.

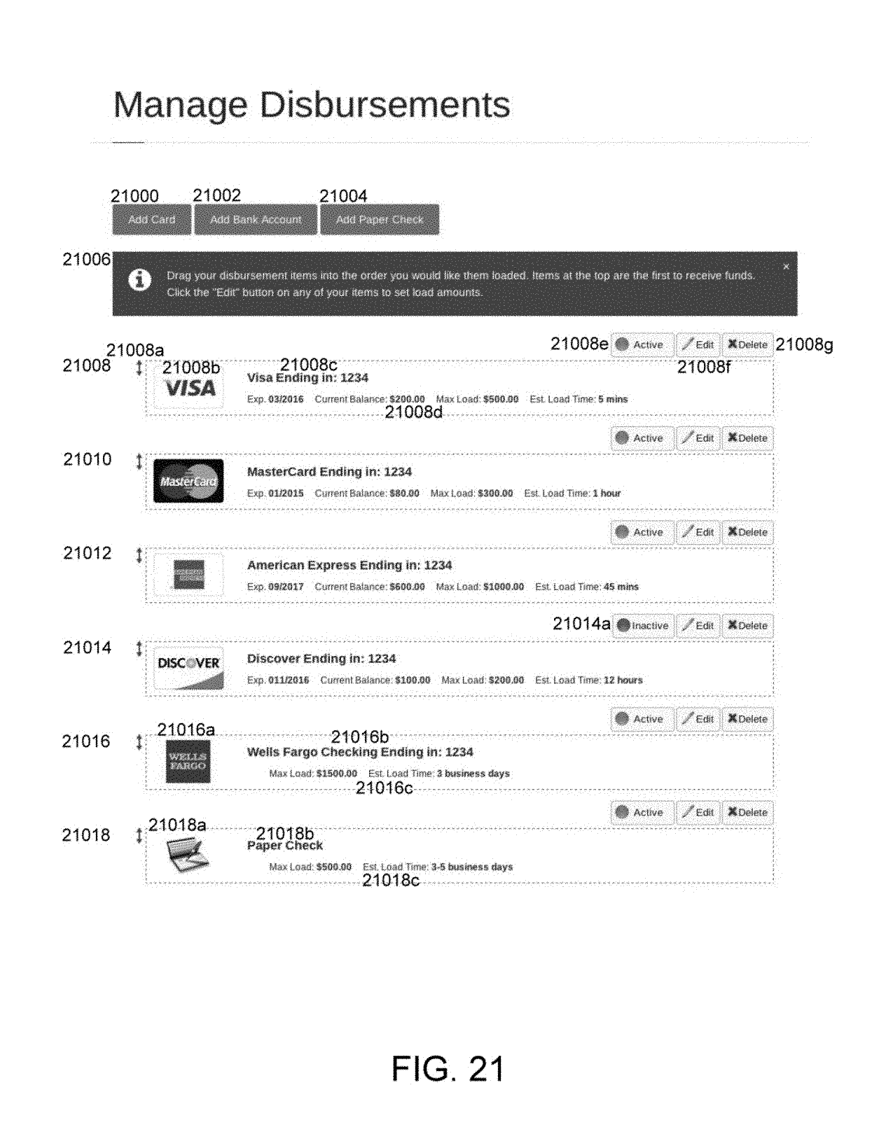

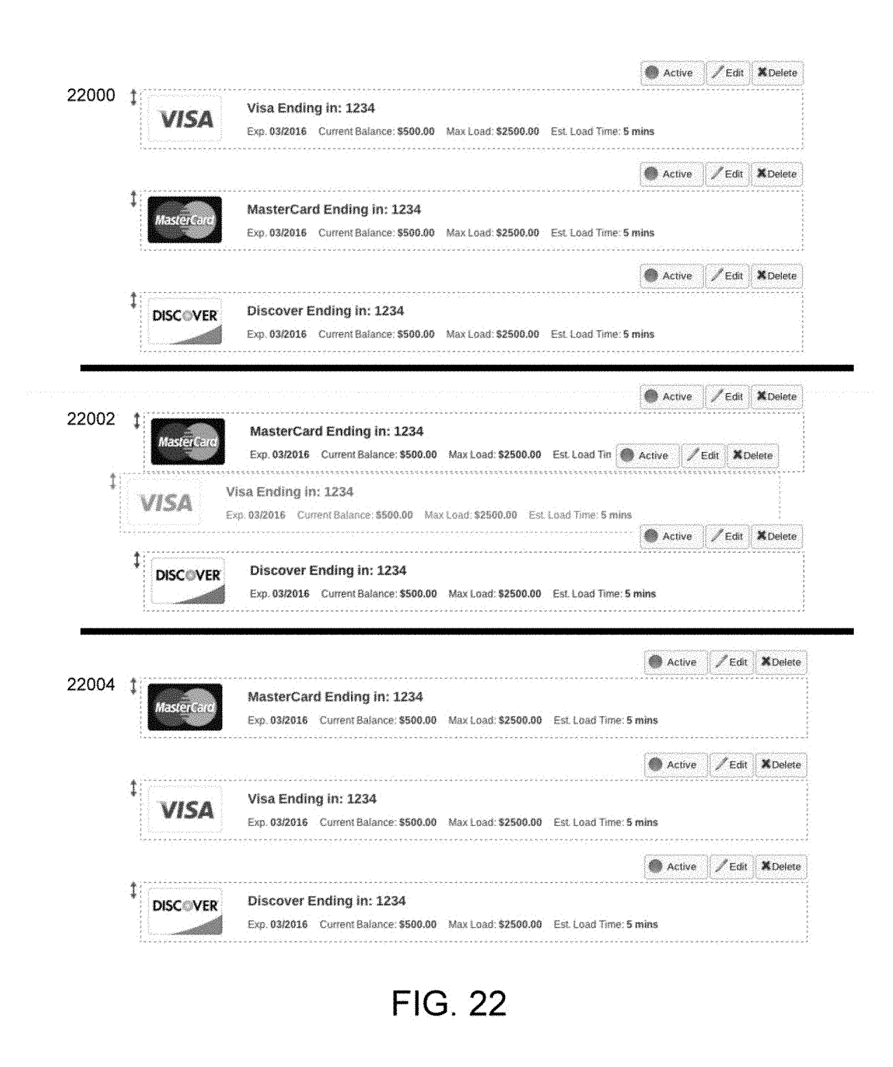

FIG. 17 (elements 17000-17032) illustrates what an interface page of the Present Invention looks like where a Payee can privately and securely edit preferences governing a new or existing PDDD—the one herein being illustrated being in the form of a reloadable credit or debit card—and set parameters that will govern its usage unless or until changed by Payee at a subsequent time. If the Edit Card Preferences window is not accessed automatically after the entry of a new card account number and expiry date (FIG. 16), the window/form is available to a Payee from a drop down menu selection from which the card's account number 17000 is available from a scrolling window of all cards/PDDDs already registered (or in progress of registration) within Payee's PDDD Account. Each PDDD has an “Active” “ON” or “OFF” toggle 17002. While Information can be added/edited at will by a Payee, only those that have been toggled as “ON” will be queued to receive funds at the time of a scheduled Payment/Disbursement Event. The card's current listed expiry date will show up automatically at 17004, but the expiration date can be manually changed at 17004a if the auto-loading number happens to be incorrect. There are a number of options available to a Payee in respect to any particular PDDD that allow a Payee to have total control over how, when, how much, how often, and governing conditions as to the loading and use of each Device. The first and simplest of such options is the selection 17006 to load a fixed dollar amount to the card at the next Payment Event (or immediately if funds are available in the Payee's Payee-Directed Disbursement Account (“PDDA”). The 17006 “radio” button must be clicked and the exact dollar amount to be loaded must be input in the field immediately to the right 1706a. When 17006 is clicked and the Active toggle is “ON”, depending upon the order in which the card is placed in the drag-and-drop load order (FIGS. 21 and 22), so long as sufficient funds are available to do so, any and every PDDD card marked for loading with a fixed amount will be loaded—in the sequence of their ordering—at the time of a Payment Event without any other input or intervention on the part of a Payee unless or until changed by subsequent Payee input or intervention. Clicking the “radio” button 17008 beside Load Variable Amount will STOP the cycle of loading a FIXED amount at Payment Events in favor of parameters to be set by Payee regarding loading of variable amounts. 17010 is an input device that can be used as a slider to set a current MINIMUM Load Amount. Under most circumstances, minimum load amount will not be less than $20.00 per load event. (Setting a minimum load amount makes more efficient use of Payee's funds as there is a loading fee charged by the financial institution when funds are credited to a card.) Moving the slider to the right will raise the number appearing in the box at the right of the slider 17010a indicating a higher minimum dollar amount to be credited with each card load. Moving the slider to the left will lower the number appearing in the box 17010a and lower the minimum load amount figure. Also, directly inputting a figure into the box will accept the input figure and move the slider in the appropriate relative raise or lower direction. Similarly, moving the slider 17012 left or right will lower or raise the number appearing in the box at the right of the line 17012a, which number establishes the MAXIMUM amount to be loaded at a Payment Event. Protections can be put on a card so that an amount not to exceed a selected figure is never loaded onto that card. This feature is activated by sliding the Max Card Balance Enforcement toggle 17014 to the “ON” position. Actual Max Card Balance or Credit Limit is input in the box at the right of the 17016 line. For those looking to build and protect their credit ratings, the Present Invention System additionally provides two helpful optional features. First of the credit-enhancing options is 17018 Overdraft Protection which is engaged by means of an “ON” toggle. As with previous slider switches, an amount is input 17020 by means of the provided slider or direct input in the appropriate box 17020a. This is an override feature that makes sure that a card that may not be scheduled to receive a fixed or variable amount will always receive enough funds at a Payment Event to assure that the card's available balance does not drop below the figure set at 17020a. More than just avoiding embarrassment when the card is presented and insufficient credit or funds are available, staying within a card's available credit line will help avoid additional bank fees, lowering of credit lines, and lowering of credit scores. The second credit enhancement option and override feature is Debt to Credit Ratio Protection 17022 where savvy Payees let the Present Invention's System monitor activity on a card by moving the corresponding toggle into the “ON” position. When engaged, the System will monitor activity of the card so that it stays loaded to a degree that does not fall below an Ideal Debt to Credit Ratio which is set by the Payee from a drop down menu 17024. Key to the effective application of this functionality is being sure that the Monthly Billing Day is correctly entered at 17026. (This calendar day may or may not be obtained by System from card issuer's database.) Present Invention's System checks card's usage against the credit limit and allocates sufficient funds to the card before the Monthly Billing Day to bring the balance on the card in line with the preset Debt to Credit Ratio. Credit reporting agencies make note of card usages which keep within ideal limits when establishing credit ratings. The higher the credit rating, the more credit available and the less the user pays for the use of such credit, making this feature extremely valuable to Payees who use it wisely. Once fields on the Edit Card Preferences are populated and selections made (or at any time in the process), Payee can click “Remove” 17028 to get a prompt regarding removing the record/device altogether, click “Cancel” 17030 to revert fields back to previous settings, or click “Save” 17032 to update Payee's PDDD database for use by Present Invention's System in carrying out PDDD loading instructions for reloadable cards.

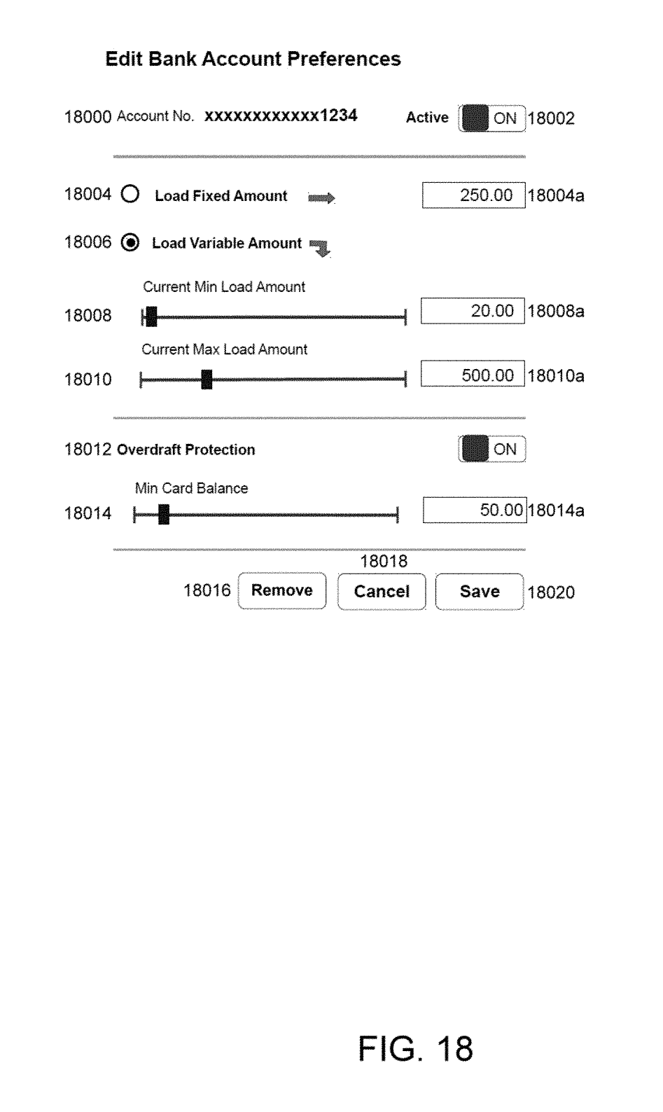

FIG. 18 (elements 18000-18020) illustrates what an interface page of the Present Invention looks like where a Payee can privately and securely edit preferences governing a new or existing PDDD—this one in the form of a bank account—and set parameters that will govern its usage unless or until changed by Payee at a subsequent time. If the Edit Bank Account Preferences window is not accessed automatically after the entry of a new Bank Account Registration, the window/form is available to a Payee from a drop down menu selection from which the bank's account number 18000 is available from a scrolling window of all PDDDs already registered (or in progress of registration) within Payee's PDDD Account. Each Bank Account PDDD has an “Active” “ON” or “OFF” toggle 18002. Information can be added/edited at will by a Payee, but only those that have been toggled as “ON” will be queued to receive funds at the time of a scheduled Payment/Disbursement Event. There are a number of options available to a Payee in respect to any particular PDDD that allow a Payee to have total control over how, when, how much, how often, and governing conditions as to the loading and use of each Device, including a Bank Account. The first and simplest of such options is the selection 18004 to load a fixed dollar amount to the Bank Account at the next Payment Event (or load immediately if funds are already available in the Payee's Payee-Directed Disbursement Account (“PDDA”). The 18004 “radio” button must be clicked and the exact dollar amount to be loaded must be input 18004a in the field immediately to the right. When 18004 is clicked and the Active toggle is “ON”, depending upon the order in which the Bank Account PDDD is placed in the drag-and-drop load order (FIGS. 21 and 22), so long as sufficient funds are available to do so, any and every PDDD marked for loading with a fixed amount will be loaded—in the sequence of their ordering—at the time of a Payment Event without any other input or intervention on the part of a Payee unless or until changed by subsequent Payee input or intervention. Clicking the “radio” button 18006 beside Load Variable Amount will STOP the cycle of loading a FIXED amount at Payment Events in favor of parameters to be set by Payee regarding loading of variable amounts. 18008 is an input device that can be used as a slider to set a current MINIMUM Load Amount. Under most circumstances, minimum load amounts will not be less than $20.00 per load event. (Setting a minimum load amount makes more efficient use of Payee's funds as there is a loading fee charged by the financial institution when funds are credited to a PDDD such as a bank account.) Moving the slider to the right will raise the number appearing in the box at the right of the slider 18008a, indicating a higher minimum dollar amount to be credited with each bank account PDDD load. Moving the slider to the left will lower the number appearing in the box 18008a and lower the minimum load amount figure. Also, directly inputting a figure into the box will accept the input figure and move the slider in the appropriate relative raise or lower direction. Similarly, moving the slider 18010 left or right will lower or raise the number appearing in the box 18010a at the right of the line, which number establishes the MAXIMUM amount to be loaded at a Payment Event. As a practical and money saving feature, the Present Invention System provides 18012 Overdraft Protection which is engaged by means of an “ON” toggle. As with previous slider switches, an amount is input 18014 by means of the provided slider or direct input in the appropriate box 18014a. This is an override feature that makes sure that a bank account that may not be scheduled to receive a fixed or variable amount will always receive enough funds at a Payment Event to assure that the account's available balance does not drop below the figure set at 18014a. More than just avoiding embarrassment when the bank's debit card is presented and insufficient funds are available, (or a check is returned NSF), Overdraft Protection will help avoid additional bank fees and lowering of credit scores due to negative credit reporting. Once fields on the Edit Bank Account Preferences are populated and selections made (or at any time in the process), Payee can click “Remove” 18016 or click “Cancel” 18018 to revert fields back to previous settings, or click “Save” 18020 to update Payee's PDDD database for use by Present Invention's System in carrying out PDDD loading instructions for bank accounts.

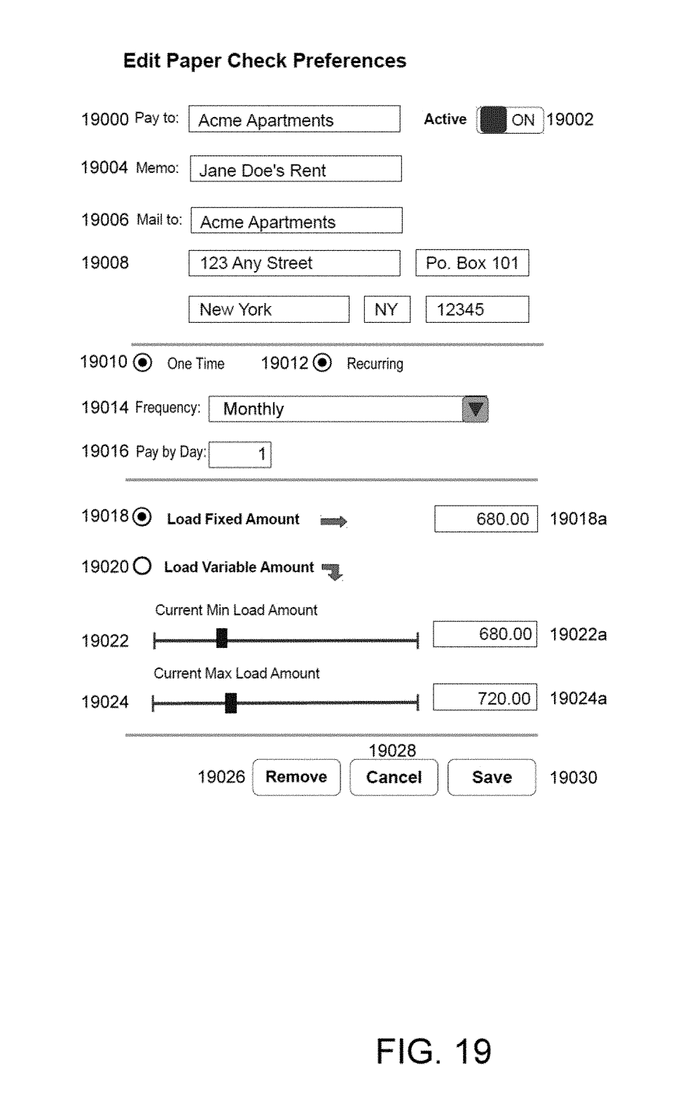

FIG. 19 (elements 19000-19030) illustrates what an interface page of the Present Invention looks like where a Payee can privately and securely edit preferences governing a new or existing PDDD—this one in the form of a paper check—and set parameters that will govern its usage unless or until changed by Payee at a subsequent time. If the Edit Paper Check Preferences window is not accessed automatically after the entry of a new Paper Check Request, the window/form is available to a Payee from a drop down menu selection from which the check's “Pay to the Order of” entry 19000 is available from a scrolling window of all checks/PDDDs already registered (or in progress of registration) within Payee's PDDD Account. Each PDDD/check has an “Active” “ON” or “OFF” toggle 19002. Information can be added/edited at will by a Payee, but only those that have been toggled as “ON” will be queued to receive funds at the time of a scheduled disbursement event. The check's current memo entry will show up automatically at 19004 but can be changed by clicking in the provided box and editing its contents. Current “Mail to” appears at 19006 but can be manually edited at will. Current Mailing Address fields will populate in section 19008, any field of which can be edited by clicking in and writing in the appropriate box. There is a “radio” button 19010 for tagging the paper check as a one-time event or another “radio” button 19012 for designating the check as a recurring expense item (such as the FIG. 19 example for rent). When “Recurring” is activated, a “Frequency” drop down menu 19014 activates to allow the choosing of frequency options such as “weekly”, “bi-weekly”, “monthly”, “quarterly”, etc. By entering a “Pay by Day” entry 19016, Payee allows the Present Invention's System to calculate the issuing of the requested check in sync with scheduled Payment Events. There are two options available to a Payee in respect to setting an amount on the check being edited. First and most obvious is the selection 19018 to enter a fixed dollar amount on the check 19018a. A “One Time” 19010 fixed dollar amount 19018a check request is issued immediately if funds are available in the Payee's Payee-Directed Disbursement Account (“PDDA”) or issued in queue order at the next scheduled Payment Event (if not overridden by the Present Invention's System for scheduling payments at certain days of the month as in 19016 above). When the Active toggle is “ON”, depending upon the order in which the paper check PDDD is placed in the drag-and-drop load order (FIGS. 21 and 22), so long as sufficient funds are available to do so, any and every PDDD, scheduled checks included, marked for loading with a fixed amount will be loaded/issued—in the sequence of their ordering—at the time of a Payment Event without any other input or intervention on the part of a Payee unless or until changed by subsequent Payee input or intervention. Clicking the “radio” button 19020 beside Load Variable Amount will STOP the cycle of loading a FIXED amount at Payment Events in favor of parameters to be set by Payee regarding loading of variable amounts. 19022 is an input device that can be used as a slider to set a current MINIMUM Load Amount. Under most circumstances, minimum load amount will not be less than $20.00 per load event. (Setting a minimum load amount makes more efficient use of Payee's funds as there are processing and postage fees charged by the financial institution when funds are issued as a check.) Moving the slider to the right will raise the number appearing in the box at the right of the slider 19022a indicating a higher minimum dollar amount to be credited with each check's issuance. Moving the slider to the left will lower the number appearing in the box 19022a and lower the minimum load amount figure. Also, directly inputting a figure into the box will accept the input figure and move the slider in the appropriate relative raise or lower direction. Similarly, moving the slider 19024 left or right will lower or raise the number appearing in the box at the right of the line 19024a, which number establishes the MAXIMUM amount to be loaded at a Payment Event. Present Invention's System will never issue a paper check if sufficient funds are not in the Payee's Payee-Directed Disbursement Account, so there are never any check returns for NSF for any System-issued check. This not only avoids embarrassment, it also insures there will never be NSF fees assessed by any check recipient or negative credit reporting based upon an NSF check. Once fields on the Edit Paper Check Preferences are populated and selections made (or at any time in the process), Payee can click “Remove” 19026 to get a prompt regarding removing the paper check request/device altogether, click “Cancel” 19028 to revert fields back to previous settings, or click “Save” 19030 to update Payee's PDDD database for use by Present Invention's System in carrying out PDDD loading instructions for issuing paper checks.

FIG. 20 (elements 20000-20028) illustrates an online or client server Payee Account Disbursement Request Form generated by Present Invention's System whereby a Payee can privately and securely request some or all currently available funds in their Payee-Directed Disbursement Account (“PDDA”) to be transferred to their current Disbursement List or to a specific PDDD. In this way, Payees can allow the proceeds of multiple Payment Events to accumulate in their PDDAs until there are enough collective funds to cover the disbursements in their Disbursement List queue. Payee's Payee-Directed Disbursement Account (“PDDA”) 20000 is identified by Payee Name and PDDA contact email. Current Account Balance 20002 (as per this illustration)—prior to either a new Payment Event or Disbursement Request—is pulled from Present Invention's System's PDDA database and displayed when the window populates. A “Details” button 20004 allows the Payee to review the latest log of distributions and disbursements. Payee inserts dollar amount 20006 being requested for disbursement and confirms the number by clicking “Update” 20008. Present Invention's System subtracts the requested Disbursement Amount 20006 from the Account's Current Balance 20002 and displays what the new balance will be 20010 once the requested Disbursement is executed. Payee may elect to have the requested Disbursement Amount 20006 transferred to the most recent Disbursement List by clicking the “radio” button 20012 which adds the new Disbursement Request to the Disbursement List. Transferring money from their PDDA to their Disbursement List causes the Present Invention's System to take over disbursement of the transferred funds to each of the Active PDDDs in the order in which they are placed and/or according to optional override instructions such as Overdraft Protection. Prior to submitting the Disbursement Request, Payee may wish to first “Manage List” of current or pending disbursements by clicking the “Manage List” button 20014 [see FIGS. 21, 22] where the Drag-and-Drop features of the List Management Page allow setting the order in which Disbursement Requests are paid out. Alternatively, Payee may choose 20016 to request a single load of or transfer to an individual Payee-Directed Disbursement Device (“PDDD”), which can be accomplished outside of the Disbursement List instructions without disturbing or triggering the entire List. A pull down menu 20018 allows the Payee to scroll through all currently registered PDDDs to select the one of choice for the current Disbursement. Also on the pull down menu will be selection options for Paper Checks, Money Orders, etc., PDDDs options that are available but may not yet be specifically registered in the Payee's Account within the Present Invention's System. Once the Payee has established to which PDDD the Disbursement is to go, several other options present themselves. Clicking 20020 allows the Payee to indicate that the transfer is a “One time Disbursement” Event that will not be retained in the Disbursement List after the transfer is accomplished. Clicking 20022 activates a drop-down menu—displaying options such as “Weekly”, “Bi-weekly”,“Monthly”, “Bi-monthly”, “Quarterly”—whereby the Payee instructs the Present Invention's System that the Disbursement is to be a “Recurring Disbursement Event” which will continue as instructed unless or until subsequently changed by Payee. To help keep track of specific disbursements, an editable Memo box allows input at 20024. By clicking “Cancel” 20026, whatever has been entered on the form is immediately erased after a prompt. Or the form is submitted for fulfillment by clicking “Submit” 20028.

FIG. 21 (elements 21000-21014) illustrates an online or client server “Manage Disbursements” page generated by the Present Invention's System whereby a Payee can privately and securely review and manage all current or pending disbursement requests for one or more Payment Events by dragging and dropping icons representing specific PDDDs into a preferred loading order as well as by giving Payee access to deactivate, edit, or remove one or more PDDDs from the loading list. This page can be accessed at any time before or subsequent to a particular Payment Event, and parameters can be set that will govern present and future disbursements unless or until changed by Payee at a subsequent time. Along with viewing and managing existing Disbursement Requests, the “Manage Disbursements” screen allows Payees to Add additional PDDDs. While numerous other PDDD options are available, for purposes of illustration, FIG. 21 shows three such addable PDDDs: a reloadable Card 21000, a Bank Account 21002, and a Paper Check 21004. Clicking on their respective buttons brings up the corresponding dialog page that enables the Payee to extend the list of disbursement options under Payee's direct control. An instructional prompt may appear 21006 to help guide the Payee through one or more processes on the page. Prompts can be cleared by clicking the “X” in the upper right hand corner of the informational box. In the FIG. 21 example, there are six Payee-Directed Disbursement Devices (“PDDDs”) showing in the Manage List. Each PDDD represented has several distinct bits of information associated with it. The two headed perpendicular arrow 21008a reminds the Payee that the selected icon and its collection of information contained within the dotted box line can be dragged and dropped either up or down at the will of the Payee. [See FIG. 22.] The position on the page, starting with the top, will determine the order in which funds received from a Payment Event or a Disbursement Request will be loaded onto the particular PDDD. 21008b shows a logo which represents either the issuing institution or the type of Disbursement Device. In the illustration, 21200b represents the VISA brand Credit/Debit Card. Information found in the position at 21008c identifies the particular Disbursement device further—in this case a VISA Card whose account number ends in “-1234”. (Present Invention's System does not allow the showing of the full account numbers on any Payee's Manage List screen for privacy and security purposes and, further, does not retain the full account numbers on its Servers.) Pertinent data specific to the PDDD and necessary at a glance is found in the position represented at 21008d. Such information includes, though it is not limited to, Maximum and Minimum Load Amounts and Estimated Load Times—which can be as quick as seconds or minutes for most reloadable cards or up to 3-5 business days for some bank transfers. Each PDDD in the list is funded in the order in which it appears, based upon whether or not its status is Active 21008e, which the subject VISA Card is. If active, a green indicator “light” shows next to the word “Active” on the corresponding tab to the upper right of the PDDD's field. [By contrast, a PDDD turned “Inactive”, though it retains its place in the lineup, will not be funded unless or until returned to Active status. 21014a examples the amber color of the corresponding “light” on the tab of the Discover Card 21014.] Clicking the relevant “Edit” tab 21008f would open the Edit Card Preferences screen [see FIG. 17] for the corresponding PDDD/Card. Clicking the “Delete” tab 21008g for a PDDD brings up a dialog box that warns the user prior to deleting the PDDD from the System. The first four items in the list—21008, 21010, 21012, 21014—are main line credit or debit cards which, having been registered in the Present Invention's System, can be reloaded at will by receiving directed disbursements from a Payee's Payee-Directed Disbursement Account (“PDDA”) as funds become available at Payment Events. These cards could also be gift cards, gas cards, phone cards, or store cards, any type and number of cards that the Present Invention's System, in communication with the original issuing institutions, allows to be reloaded within parameters set by the issuers and bank regulators. A bank account 21016 is showing in the fifth position in the list, with a written description of the Account illustrated at position 21016b. However, because the Discovery Card in fourth position is showing as currently “Inactive”, the Bank Account 21016 would be loaded fourth upon a Payment Event, by-passing the inactivated 21014 Discover Card. Bank Accounts can receive any amount up to 100% of a Payment Event's proceeds or an accumulated amount from several Events. Transferring funds to one or more Bank Accounts is still an option for Payees who do not have bank accounts where such bank account loadings can facilitate covering expenses such as rental payments, mortgage payments, tuition, or any other type of timed payment—all of which can be allocated and disbursed to such accounts as any other regular PDDD under the direct control of the Payee. Additional Bank Account information is available at a glance at 21016c. [For Payees who have bank accounts of their own and who wish all the Payment Event proceeds to go to such a bank account, the 3-5 day wait time for funds to transfer to their bank accounts may not work in their best interests. Payees looking for faster disbursement to their bank accounts (should they have them) are able to register their bank account's DEBIT Card as a PDDD instead of their bank account by way of direct deposit, Transfers to a bank account debit card can often be effected within mere minutes, as opposed to several days for a transfer.] A paper check 21018 is indicated by an open checkbook icon 21018a, identified as a “Paper Check” 21018b, and further clarified at 21018c. Paper Checks as PDDDs are available whether or not Payee has a personal banking account. Another helpful feature is that Payees can have multiple Disbursement Management lists to help handle expenses that come due at different times of the month that correspond better with their flow of compensation.

FIG. 22 (elements 22000-22004) illustrates the Present Invention's online or client server action on the Manage Disbursements page (FIG. 21) whereby one or more of a Payee's PDDDs is moved into a new loading order, with the FIG. 21 illustration showing the before 22000, during 20002, and after 20004 positions as the changes are being made. Three icons representing three different electronically reloadable credit/debit cards as PDDDs are shown. All three icons/PDDDs are listed as “Active”, meaning that all three qualify for loading when sufficient funds are available. In order of original loading priority 22000, the VISA Card would load first, followed by the MasterCard, and then the Discover Card. By clicking and holding on the VISA Card icon while dragging downward on the page 22002, the VISA Card, with all of its information attached, is shown being moved into the second position on the page while the Present Invention's System automatically moves the MasterCard icon and all of its attached information from previous second place into the first position. 22004 illustrates the new positioning after the VISA Card has been released by the Payee into the second position. During the transition, the Discover Card retains its position in third priority. The drag-and-drop functionality of the Present Invention' ;s System could have as easily raised the now first positioned MasterCard to the top position , which would have forced the VISA Card into the second position.

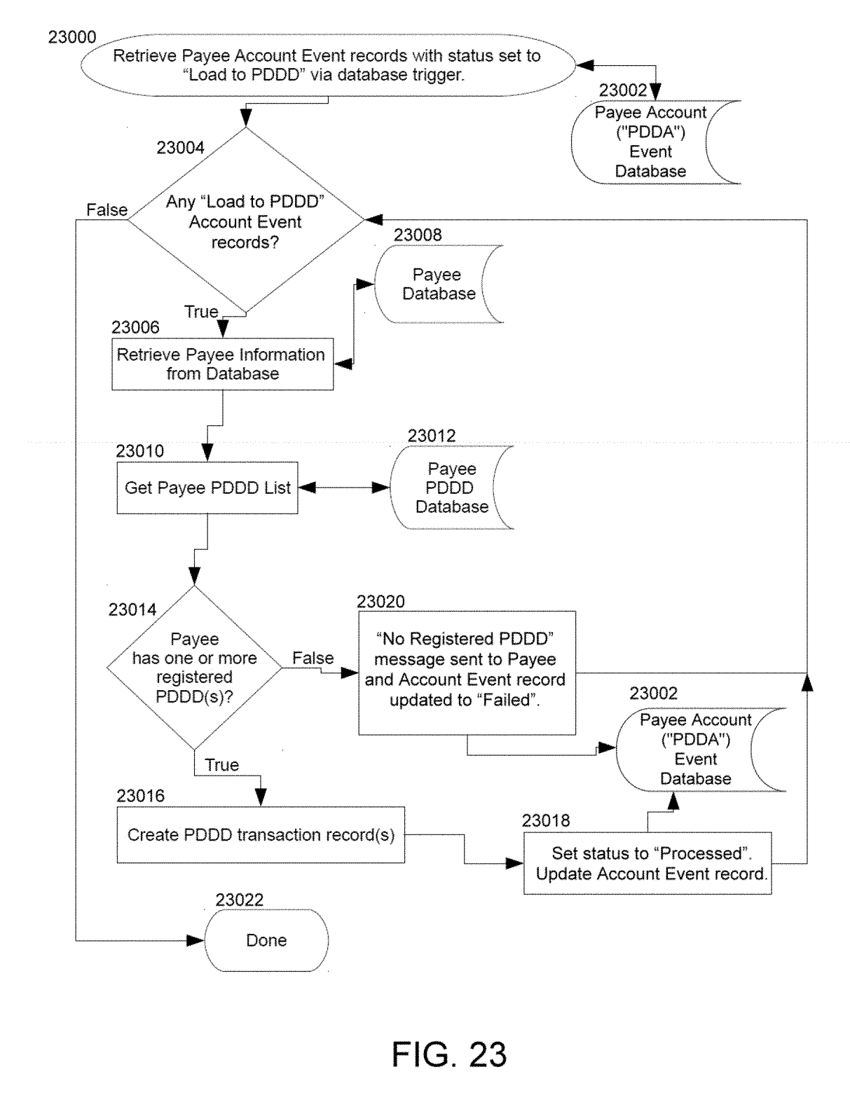

FIG. 23 (elements 23000-23022) is a flowchart which illustrates the internal steps whereby the Present Invention's System retrieves and processes Payee Account (PDDA) Event Records with status set to “Load to PDDD” via database trigger. Should a designated Payee have funds credited to his or her Payee-Directed Disbursement Account (“PDDA”) and have instructed Present Invention's System to move some or all of said funds to one or more Payee-Directed Disbursement Devices, Present Invention's System takes over the facilitation of such disbursement(s) in the following manner. Present Invention's System retrieves 23000 Payment Event information from Payee-Directed Disbursement Account database 23002 by listening for any triggers from 23004 regarding any “Load to PDDD” Account Event records. If the answer to the query returns as False, System terminates the then current query 23022 and continues to listen for new database triggers. If the 23004 query is returned as True, System retrieves Payee Information from Payee Database 23008. Then System retrieves 23006 Payee PDDD List from 23012 Payee PDDD Database and queries 23014 whether Payee has one or more registered PDDD(s). If 23014 query returns False (meaning there are no registered PDDDs in Payee's Database, Present Invention System sends “No Registered PDDD” Message to Payee, updates Account Event record 23002 to “Failed”, and returns to query System 23004, looking for any “Load to PDDD” Account Event records. If query 23014 regarding whether Payee has one or more registered PDDDs returns as True, System 23016 creates the appropriate PDDD record(s), sets status to “Processed” and updates Account Event record 23018 to Payee PDDA Event Database 23002 and returns to query System 23004, looking for any “Load to PDDD” Account Event records.

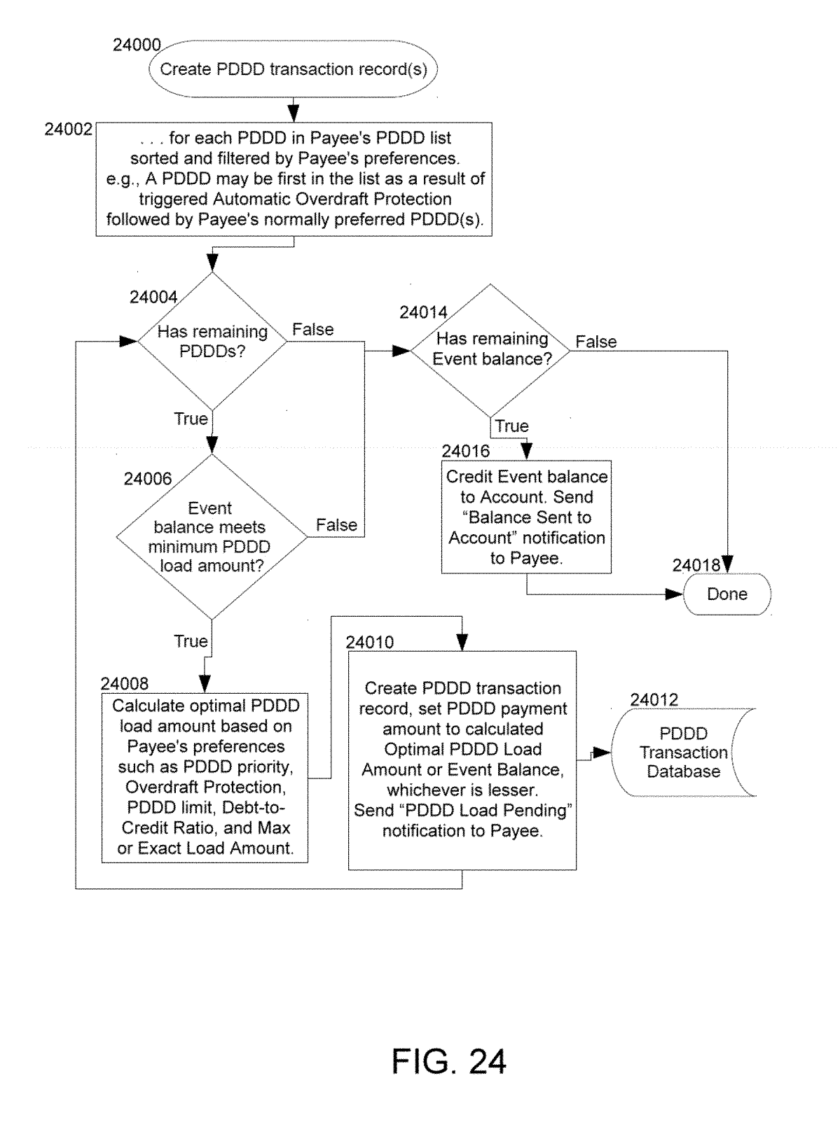

FIG. 24 (elements 24000-24012) is a flowchart which illustrates the internal steps whereby Present Invention's System creates PDDD transaction records for each PDDD in Payee's PDDD list as modified by certain other triggers such as Automatic Overdraft Protection. Present Invention System 24000 creates PDDD transaction records for each 24002 PDDD in Payee's PDDD list, sorted and filtered by Payee's preferences. E.g., a PDDD may be further down in the normal loading order list [FIG 21] but may be loaded first of all PDDDs in the queue as a result of triggered Automatic Overdraft Protection or some other Payee-selected Option, followed by Payee's normally preferred PDDDs. Present Invention queries 24004 Present Invention's System, looking for any remaining Payee PDDDs.

If the answer to the query is False, System queries to determine if there is a remaining Payment or Disbursement Event balance 24014. If that returns False, System terminates 24018 “Create PDDD Transaction Record” process. If the answer to the 24004 query (“Has Remaining PDDDs?) is True, System queries 24006 to determine if there is a remaining Payment or Disbursement Event balance which meets the Minimum PDDD Load Amount 24006. If that returns False, System queries to determine if there is a remaining Payment or Disbursement Event balance 24014. If that returns False, System terminates Create PDDD Transaction Record process. If the answer to the 24004 query (”Has Remaining PDDDs?) is True, the System follows with a query to determine if there is a remaining Payment or Disbursement Event balance 24006 which meets the Minimum PDDD Load Amount. If that returns True, Present Invention's System 24008 calculates the optimal PDDD Load Amount based upon Payee's preferences, such as PDDD loading priority, Overdraft Protection, PDDD Loading Limit, Debt-to Credit Ratio, and Maximum or Exact Load Amount. Present Invention System 24010 creates a PDDD Transaction Record (which is sent to 24012 PDDD Transaction Database), sets PDDD Payment Amount to calculated Optimal PDDD Load Amount or Event Balance, whichever is lesser, sends “PDDD Load Pending” notification to Payee, and goes back to 24004, looking for any remaining PDDDs.

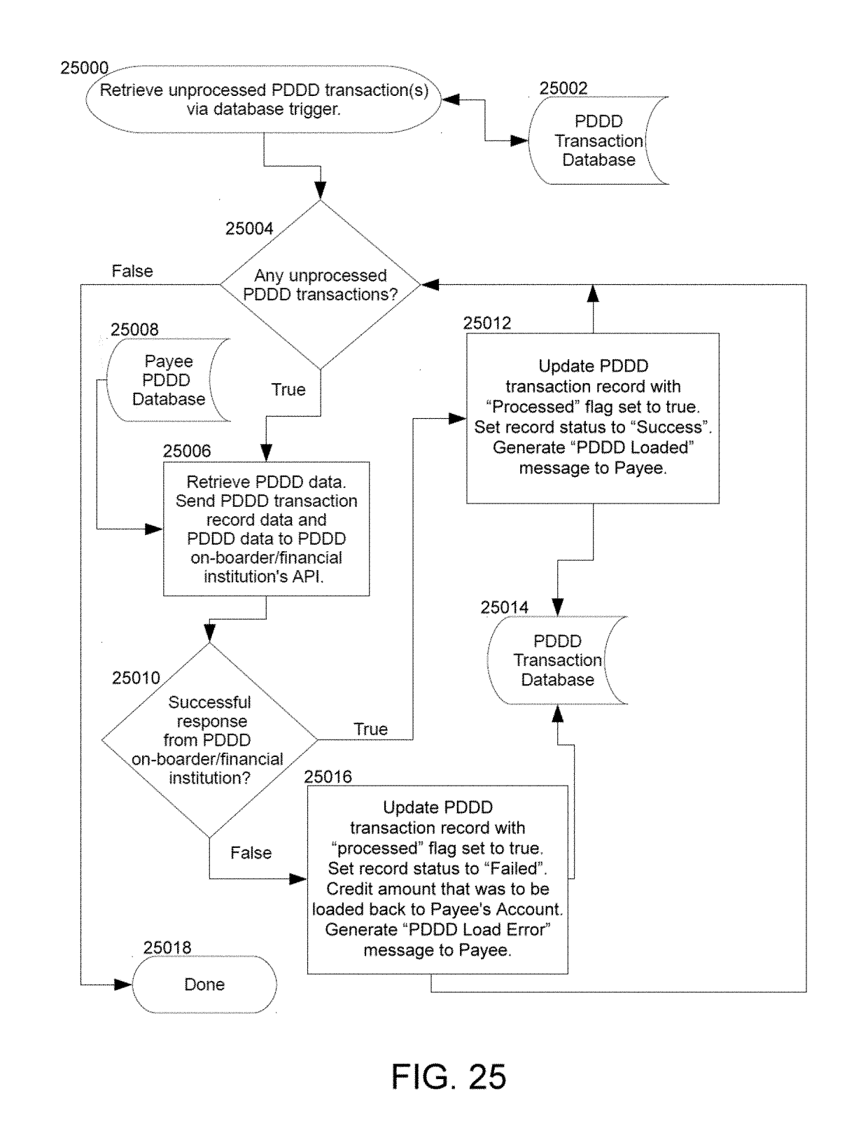

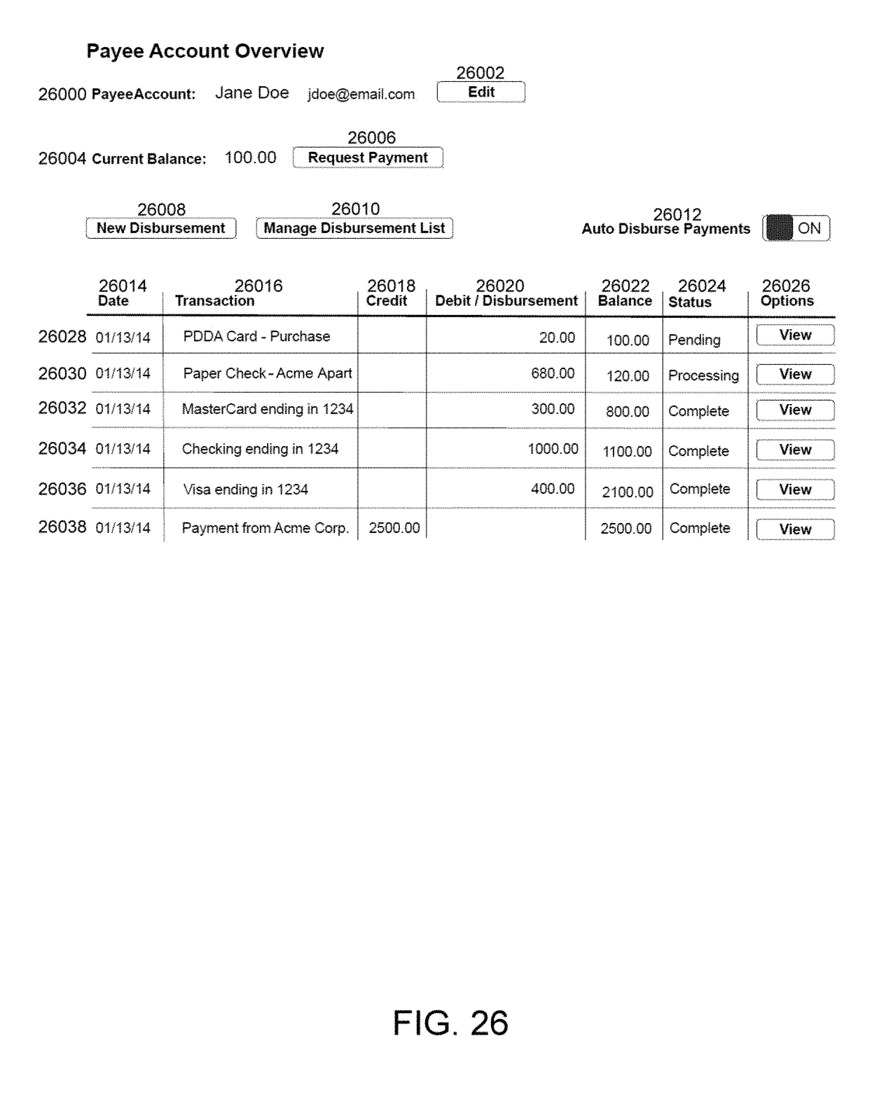

FIG. 25 (elements 25000-25018) is a flowchart which illustrates the internal steps whereby Present Invention's System retrieves and handles unprocessed PDDD transactions via a database trigger. Whether in the normal course of processing a Payment Event Distribution or whether, on occasion, a Payment Event may be interrupted or postponed for various issues (such as lack of active Payee account or insufficient funds in Payer's Payer-Controlled Pay Account), Present Invention's System is designed to either continue the distribution cycle uninterrupted or to pick up where the System left off if interrupted and 25000 retrieve unprocessed PDDD transaction(s) via database trigger sent by 25002 PDDD Transaction Database. Having received such a trigger, Present Invention's System queries 25004 for “Any Unprocessed PDDD Transactions?” Should the query return False, System terminates the then current data find and response 25018. Should the System query 25004 for “Any Unprocessed PDDD Transactions?” return True, System retrieves PDDD data 25006 from 25008 Payee PDDD Database, sends PDDD Transaction Record Data and PDDD data to PDDD's on-boarder/Financial Institution's API. Following, Present Invention's System awaits a Response 25010 from PDDD on-boarder/Financial Institution. Should response return False, Present Invention's System 25016 Updates PDDD Transaction Record (in 25014 PDDD Database) with “Processed” flag set to “True”, sets record status to “Failed”, credits amount that was to be loaded back to Payee's Account, generates “PDDD Load Error” message to Payee”, and cycles back to query 25004 for “Any Unprocessed PDDD Transactions”. Should 25010 response from PDDD on-boarder/Financial Institution return True (“Successful”—meaning on-boarder/financial institution has taken possession of the funds that had been deducted from PDDA), Present Invention's System 25012 Updates PDDD Transaction Record (in 25014 PDDD Database) with “Processed” flag set to “True”, sets record status to “Success”, generates “PDDD Loaded” message to Payee”, and cycles back to query 25004 for “Any Unprocessed PDDD Transactions”. FIG. 26 (elements 26000-26026) illustrates what the Payee Account Overview page looks like when generated by the Present Invention on the Present Invention's Server System, where each disbursement is tracked and labeled as to its status while updating the Payee's Payee-Directed Disbursement Account balance. 26000 identifies the Payee by name and by official email address, which information can be edited at any time by Payee by clicking “Edit” 26002, opening the Edit Payee Information Page. [See FIG. 15.] 26004 shows the current balance within Payee's Payee-Directed Disbursement Account (“PDDA”). By clicking 26006 “Request Payment”, Payee may open a dialog box from which Payee may request a Payment from or generate an invoice to any Payer who may owe money for any reason. Clicking 26008 “New Disbursement” opens the Payee Account Disbursement Request Form [FIG. 20]. Clicking 26010 “Manage Disbursement List” opens the Manage Disbursement page [FIG. 21]. Toggling “Auto Disburse Payments” 26012 to “ON”, directs Present Invention's System to carry out all currently “Active” Payee-Directed Disbursement Orders automatically as Payment Events supply funds to do so. Payee Account Overview is divided into seven (7) columns. 26014 is the column where the transaction dates are recorded. 26016 chronicles what the Transactions were/are/are scheduled to be. 26018 posts as a credit any transaction where compensation flows TO Payee's PDDA. 26020 posts as a debit/disbursement any transaction where compensation flows FROM Payee's PDDA either as a payment or a transfer. 26022 records the PDDA account balance following any particular transaction. 26024 indicates the status of any transaction, whether it is “Pending” (usually awaiting confirmation that a process can begin), “Processing” (payment is in transit either electronically or physically or both), or “Complete” (all funds transferred and notifications are finalized). 26026 has to do with options, most of which center around the ability to click the “View” button to view the complete record of the particular transaction in question. Transaction records show up with oldest being at the bottom of the Transaction Report and most recent at the top. 26038 shows a transaction having been initiated on Jan. 13, 2014 that was a Payment Event from Payer Acme Corp. showing as a credit in the amount of $2500.00, which created a balance of $2500.00 in the account, having been completed. 26036 shows a transaction having been initiated on Jan. 13, 2014 that was a loading or payment disbursement made to a VISA Card in the amount of $400.00, which left an account balance in the PDDA of $2100, and is “Complete”. 26034 shows a transaction dated Jan. 13, 2014 that was a direct deposit transfer to a checking account in the amount of $1000.00, leaving $1100 in the PDDA account. Transaction is “Complete”. 26032 shows a transaction having been initiated on Jan. 13, 2014 that was a loading or payment disbursement made to a MasterCard in the amount of $300.00, which left an account balance in the PDDA of $800, and is a completed transaction. 26030 shows a transaction that was initiated on Jan. 13, 2014 in the form of a paper check to that was a payment disbursement to Acme Apartments for a month's rent in the amount of $800.00, and left an account balance in the PDDA of $120, and is currently “Processing”. 26028 shows a transaction having been initiated on Jan. 13, 2014 that was a purchase made using the PDDA linked PDDC debit card in the amount of $20.00, which left (or will leave) a balance of $100 in the account when it is completed, which, at this point in time, it is not, but is rather still “Pending”.

What is claimed is:

1. A method, via a client server system, by which a Compensation Payer can issue individual or bulk funds to a secure Payer account—typically accompanied by (a) payment manifest(s)—which automatically and verifiably distributes to Payee controlled accounts from which Payees can privately direct some or all of the received compensation to multiple Payee-Directed Disbursement Devices.

2. The method of claim 1, further comprising:
the ability of the system to be used as a standalone pay system or as an add on option to an existing pay solution;
the option of subscribed Payer(s) of Compensation to handle Payouts to one or more Payees via bulk transfers of funds as well as making multiple transfers to multiple Payees;
the way in which funds are paid over by the Payer(s) of Compensation and transferred to a receiving transfer account;
the monitoring of the cash balance from the Payer(s) of Compensation in their respective receiving transfer account(s), where said funds balances in such account(s) are accounted against the Payment Manifest(s) from the Payer(s) of Compensation and said Payer(s) are alerted as to any discrepancies, including, but not limited to, insufficient funds;
the distribution of as many received funds from the Payer(s) of Compensation according to said Payer(s)' Payment Manifest(s) as the amount of received funds will allow, holding any other disbursements until sufficient funds have been received;
allowance of Payer(s) of Compensation to cancel or withdraw Payout Request(s) for any designated Payee for any reason deemed necessary by Payer(s) up to the moment that such Payee disbursement has been tagged as “Processing” or “Paid”;
automatic execution of Payout distribution(s) of said bulk funds to Payer(s)' designated Payee(s) according to an accompanying Payer-generated Payment Manifest;
verifiable distribution of said bulk funds received from the Payer(s) of Compensation as directed by the accompanying Payment Manifest(s) to Payee-registered and controlled pay accounts (otherwise known as “Payee-Directed Disbursement Accounts”—“PDDAs”);
notification to Payers of Compensation when Payout transactions have been completed;
notification and possible return of funds designated for any Payee who fails to register for receipt of Payer's paid out funds transferred to a secure Payer account;
allowance of each registered Payee at all times to privately and securely receive, accumulate, access, control, and disburse in whole or in part the funds received in his or her individual PDDA:
without Payee's need of a personal bank account;
without the typical constraints and limitations of a conventional single card Pay Card system;
without limitations upon Payees' disbursement selection by Payer-determined choices;
without in any way relying on the Payer of compensation to carry out such disbursement directions;
without in any way disclosing the details of such actions and disbursements to any party or system directly connected with and/or accessible to the Payer of Compensation where such details could become known internally or through a Payer-side security breach;
access of each Payee to a private Payee Client User Interface (“PCUI”) comprising: 24/7 online access;
ability to:
establish/edit secure identity;
receive Payee input as to full particulars for registering one or more Payee Directed Disbursement Devices (“PDDDs”),
establish, control, edit, and carry out Payee's disbursement wishes according to Payee's instructions for loading amounts, loading frequencies, and loading sequences via drag-and-drop drop accessibility;
enablement of (a) subscribed Payee(s) to immediately access 100% of his/her/their received Payment Event funds through one or more Payee Directed Disbursement Cards (“PDDCs”) which cards are issued to the respective Payees and linked to their PDDAs;
enablement of any subscribed Payee to privately self-direct disbursement of funds received in his or her PDDAs by means other than by cash whether or not such Payee has access to conventional banking or bank accounts;
enablement of subscribed Payees to privately control and channel some or all of Payee's funds received in their individual PDDAs from any particular Payment Event or Events—where such funds have not been paid out or withdrawn via the directly linked PDDC cards—and simultaneously access, utilize, and disburse such remaining funds in whole or in part to one or more Payee Directed Disbursement Devices (“PDDDs”) such, devices comprising:
direct deposit,
paper checks,
e-checks,
money orders, and
virtually any kind, number, and combination of verifiably legitimate cards and electronic funds and/or storage media—without exclusion of others—where such may comprise:
smart phones,
mobile devices,
debit cards,
credit cards,
gas cards,
phone cards,
gift cards,
and store cards.

3. The method, pursuant to claim 1, whereby Payees, solely and confidentially, control and direct disbursement of funds in their PDDAs to such PDDDs by means of (a) Disbursement Manifest(s) and which said Payout Manifest(s) Payees can establish and modify at will prior to or subsequent to receipt of funds into a PDDA from a Payer of Compensation.

4. The method, pursuant to claim 2, whereby Payees, solely and confidentially, control and direct disbursement of funds in their PDDAs to such PDDDs by means of (a) Disbursement Manifest(s) and which said Payout Manifest(s) Payees can establish and modify at will prior to or subsequent to receipt of funds into a PDDA from a Payer of Compensation.

5. The method, pursuant to claim 3, whereby Distributions designated in Payees' Disbursement Manifest(s) can be prioritized, perhaps among other directives and filters, by at least one or more parameters comprising:
priority by device,
priority by device type,
priority by dollar amounts,
priority by date(s),
priority by balance amount(s),
priority by automated bill payment services,
at Payee's directions received prior to or anytime after a specific pay event disbursement.

6. The method, pursuant to claim 4, whereby Distributions designated in Payees' Disbursement Manifest(s) can be prioritized, perhaps among other directives and filters, by at least one or more parameters comprising:
priority by device,
priority by device type,
priority by dollar amounts,
priority by date(s),
priority by balance amount(s),
priority by automated bill payment services,
at Payee's directions received prior to or anytime after a specific pay event disbursement.

7. The method, pursuant to claim 1, whereby a Payee can collectivize or consolidate funds and amounts held in one or more Payee-Directed Disbursement Device(s) and designate such funds to be paid out to a named recipient or to any other 35 one or more designated Payee-Directed Disbursement Device(s).

8. The method, pursuant to claim 2, whereby a Payee can collectivize or consolidate funds and amounts held in one or more Payee-Directed Disbursement Device(s) and designate such funds to be paid out to a named recipient or to any other one or more designated Payee-Directed Disbursement Device(s).

9. The method, pursuant to claim 3, whereby the Payee can instruct the System to monitor cash or credit balances of one or more of Payee's PDDDs according to parameters the Payee can establish in Payee's Disbursement Manifest either on a single event or recurring basis for any or each such PDDD account:
alerting Payee of any discrepancies, such discrepancies or anomalies, among others, comprising:
insufficient funds;
credit monitoring, such as nearing or reaching credit or spending limits such as preset dollar amounts or debt to asset and debt to balance ratios;
overdraft notices;
Payee-set parameters;
suggesting appropriate action(s);
executing Payee Pre-programmed instructions.

10. The method, pursuant to claim 4, whereby the Payee can instruct the System to monitor cash or credit balances of one or more of Payee's PDDDs according to parameters the Payee can establish in Payee's Disbursement Manifest either on a single event or recurring basis for any or each such PDDD account:
alerting Payee of any discrepancies, such discrepancies or anomalies, among others, comprising:
insufficient funds;
credit monitoring, such as nearing or reaching credit or spending limits such as preset dollar amounts or debt to asset and debt to balance ratios;
overdraft notices;
Payee-set parameters;
suggesting appropriate action(s);
executing Payee Pre-programmed instructions.

11. The method, pursuant to claim 7, whereby the Payee can instruct the System to monitor cash or credit balances of one or more of Payee's PDDDs according to parameters the Payee can establish in Payee's Disbursement Manifest either on a single event or recurring basis for any or each such PDDD account:
alerting Payee of any discrepancies, such discrepancies or anomalies, among others, comprising:
insufficient funds;
credit monitoring, such as nearing or reaching credit or spending limits such as preset dollar amounts or debt to asset and debt to balance ratios;
overdraft notices;
Payee-set parameters;
suggesting appropriate action(s);
executing Payee Pre-programmed instructions.

12. The method, pursuant to claim 8, whereby the Payee can instruct the System to monitor cash or credit balances of one or more of Payee's PDDDs according to parameters the Payee can establish in Payee's Disbursement Manifest either on a single event or recurring basis for any or each such PDDD account:
alerting Payee of any discrepancies, such discrepancies or anomalies, among others, comprising:
insufficient funds;
credit monitoring, such as nearing or reaching credit or spending limits such as preset dollar amounts or debt to asset and debt to balance ratios;
overdraft notices;
Payee-set parameters;
suggesting appropriate action(s);
executing Payee Pre-programmed instructions.

13. A method whereby a Payee can collectivize or consolidate funds and amounts held in one or more Payee-Directed Disbursement Device(s) and designate such funds to be paid out to a named recipient or to any other one or more designated Payee-Directed Disbursement Device(s);

14. The method, pursuant to claim 13, whereby Distributions designated in Payees' Disbursement Manifest(s) can be prioritized, perhaps among other directives and filters, by at least one or more parameters comprising:
priority by device,
priority by device type,
priority by dollar amounts,
priority by date(s),
priority by balance amount(s),
priority by automated bill payment services, at Payee's directions received prior to or anytime after a specific pay event disbursement.

15. The method, pursuant to claim 13, whereby the Payee can instruct the System to monitor cash or credit balances of one or more of Payee's PDDDs according to parameters the Payee can establish in Payee's Disbursement Manifest either on a single event or recurring basis for any or each such PDDD account:
alerting Payee of any discrepancies, such discrepancies or anomalies, among others, comprising:
insufficient funds;
credit monitoring, such as nearing or reaching credit or spending limits such as preset dollar amounts or debt to asset and debt to balance ratios;
overdraft notices;
Payee-set parameters;
suggesting appropriate action(s);
executing Payee Pre-programmed instructions.
